(19) United States
(12) Patent Application Publication
(10) Pub. No.: US 2026/0265490 A1
(43) Pub. Date: Sep. 10, 2026

(54) FLAME RETARDANTS FOR ELASTIC POLYAMIDE COMPOSITIONS

(71) Applicant: Ascend Performance Materials Operations LLC, Houston, TX (US)

(72) Inventor: Kimberly M. White, Houston, TX (US)

(21) Appl. No.: 19/165,707

(22) PCT Filed: Mar. 21, 2024
(86) PCT No.: PCT/US2024/020974

§ 371 Date: Sep. 16, 2025

Related U.S. Application Data
(60) Provisional application No. 63/491,330, filed on Mar. 21, 2023.

(51) Int. Cl. C08K 5/20; C08K 5/00; C08K 5/053

(52) U.S. Cl. CPC C08K 5/20; C08K 5/0066; C08K 5/053; C08K 2201/014

(57) ABSTRACT

A polyamide composition comprising 50 to 90% by weight of an aliphatic polyamide comprising a dimer monomer and 3 to 40% by weight of a non-halogen flame retardant composition. The non-halogen flame retardant composition comprises a polyalcohol, and one or more phosphorous-containing flame retardants, nitrogen-containing flame retardants or combinations thereof, wherein the entirety of the components amounting to 100% by weight.

### PRIORITY CLAIM

The present application claims priority to U.S. Provisional Application No. 63/491,330, filed on Mar. 21, 2023, the entire contents and disclosure of which is hereby incorporated by reference.

### FIELD

The present disclosure relates generally to flame retardants for elastic polyamide compositions. The polyamide compositions possess excellent fire resistance and thus have application for several moldings, injection-molded parts, extrusion compounds and/or extruded parts.

### BACKGROUND

Polyamides are used in increasingly demanding applications, in particular as electronic parts and vehicle parts, due to their high durability and strength. Some polyamide compositions can be formulated to have high melting points, high recrystallization temperatures, fast injection molding cycle times, high flow, toughness, elasticity, chemical resistance, flame retardancy, and/or abrasion resistance.

These additives are often used in what are known as flame retardant systems which are composed of combinations of the specified classes of compounds. In practice, formulation of flame-retardant molding compositions is difficult because there is a number of requirements placed upon the molding compositions, to some extent running contrary to the side effects caused by modification with flame retardant.

As one example, in the automotive industry there is an environmental need to reduce emissions and to increase the efficiency of fuel consumption. One approach towards achieving these goals is to reduce overall vehicle weight by substituting metal components. Thermoplastics such as polyamide compositions have been employed to provide such weight reduction in the engine compartment. Some of these polyamide compositions have also been found to be particularly well suited for automotive use due to their aforementioned heat resistance, mechanical strength, and overall appearance. Exemplary applications can include tubing or jacketing for oil and gas or chemical applications, aerospace applications, wire and cable applications, back panels for the solar industry, various consumer applications, and automotive applications.

European Publication No. 4,112,680 A1 discloses flame-retardant polyamide molding compounds with a low phosphorus content. This composition is used for polyamide having at least 8 carbons per amide unit and uses metal-free aryl phosphates flame retardants.

Thus, there remains a need for improvements to polyamide compositions that have good flame retardancy and are characterized by high elongation at break.

### SUMMARY

In one embodiment, the disclosure is to a polyamide composition comprising 50 to 90% by weight of an aliphatic polyamide comprising a dimer monomer, preferably a dimer monomer having 18 to 44 carbon atoms, and 3 to 40% by weight of a non-halogen flame retardant composition comprising a polyalcohol, and one or more phosphorous-containing flame retardants, nitrogen-containing flame retardants or combinations thereof, wherein the entirety of the components amounting to 100% by weight. In one embodiment, the dimer monomer comprises a dimer acid monomer or a dimer amine monomer. Aliphatic polyamide may comprise a first monomer having 10 to 14 carbon atoms and a second monomer having 6 carbon atoms. In one embodiment, the polyalcohol may comprise at least one from the group of pentaerythritol, dipentaerythritol, tripentaerythritol, or combinations thereof. In one embodiment, the phosphorous-containing flame retardants comprise at least one from the group of phosphazenes, polyphosphates, polyphosphonates, aryl phosphates, organophosphates, diphosphates, or combinations thereof. Preferably, the polyamide composition is free of metals and halogens.

In one embodiment, the disclosure is to a polyamide composition comprising an aliphatic polyamide comprising a dimer acid monomer having from 18 to 44 carbon atoms, and a non-halogen flame retardant composition comprising a polyalcohol, and one or more phosphorous-containing flame retardants, nitrogen-containing flame retardants or combinations thereof. The composition may comprise from 50 to 90% by weight of the aliphatic polyamide and 3 to 40% by weight of the non-halogen flame retardant composition, wherein the entirety of the components amounting to 100% by weight.

In one embodiment, the disclosure is to a polyamide composition comprising an aliphatic polyamide comprising a dimer amine monomer having from 18 to 44 carbon atoms, and a non-halogen flame retardant composition comprising a polyalcohol, and one or more phosphorous-containing flame retardants, nitrogen-containing flame retardants or combinations thereof. The composition may comprise from 50 to 90% by weight of the aliphatic polyamide and 3 to 40% by weight of the non-halogen flame retardant composition, wherein the entirety of the components amounting to 100% by weight.

In one embodiment, the disclosure is to a polyamide composition comprising an aliphatic polyamide of Formula A or Formula B:

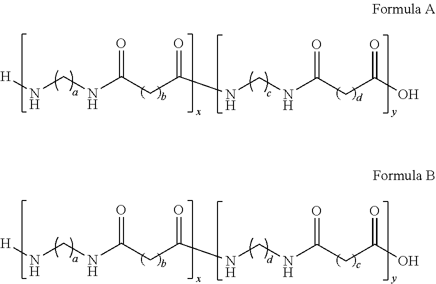

wherein X+Y=100% by weight for the copolymers, wherein a, b, c, d, are from 4 to 44, provided that a is 6 or less, then b is from 10 to 14 or b is 6 or less, then a is from 10 to 14; c is 14 or less; and d is from 16 to 44, and a non-halogen flame retardant composition comprising a polyalcohol, and one or more phosphorous-containing flame retardants, nitrogen-containing flame retardants or combinations thereof. The composition may comprise from 50 to 90% by weight of the aliphatic polyamide and 3 to 40% by weight of the non-halogen flame retardant composition, wherein the entirety of the components amounting to 100% by weight.

In one embodiment, the disclosure is to a polyamide composition comprising 50 to 90% by weight of an aliphatic polyamide comprising a dimer monomer; and 3 to 40% by weight of a non-halogen flame retardant composition comprising a polyalcohol, a triazine, a polyphosphonate, an aryl phosphate; and a diphosphonate, a phosphazene, and/or a plasticizer, wherein the entirety of the components amounting to 100% by weight. In one embodiment, the polyalcohol may comprise at least one from the group of pentaerythritol, dipentaerythritol, tripentaerythritol, or combinations thereof. In one embodiment, the triazine may at least one from the group of melamine phosphates, melamine cyanurates, or combinations thereof. In one embodiment, the phosphazenes may comprise cyclic phenoxyphosphazene, linear phenoxy phosphazene, or phenoxy phosphazene. The phosphazene may comprise hexaphenoxylcyclotriphosphazene (HPCTP). In one embodiment, the diphosphonates may comprise dimethyl pentaerythritol diphosphonate, dibenzyl pentaerythritol diphosphonate, diphenyl pentaerythritol diphosphonate and dinaphthyl pentaerythritol diphosphonate.

In another embodiment, the disclosure is to an injection molded article. The article includes any of the provided polyamide compositions.

In yet another embodiment, the disclosure is to a three-dimensional article. The three-dimensional article includes any of moldings, injection-molded parts, extrusion compounds and/or extruded parts. In one embodiment, the three-dimensional article may be antenna frames, bus bars, cables, capacitor housings, cell phone frames, circuit boards, circuit breakers, coil elements, connector sockets, connectors, terminal blocks, encapsulating compounds, engine covers, flexible printed circuit boards, lamp housings, laptop frames, LED housings, plug connectors, power plugs, sensor housings, or other electronic components or housings.

### DETAILED DESCRIPTION

The present disclosure is directed, in part, to a flame retardant polyamide composition. In one embodiment, the polyamide composition may comprise a polyamide having a dimer and non-halogen flame retardant composition. It has been found that the compositions described herein are thermally stable and are characterized has having high elongation at break. This makes the polyamide composition sufficient for demanding applications, in particular for bus bars.

In one aspect, a polyamide composition is disclosed. The composition includes a polyamide polymer and a dimer monomer, which may comprise a dimer acid or a dimer amine or a combination thereof. As described in greater detail below, in some cases, the aliphatic polyamide comprises from 5% by weight to 55% by weight of the dimer monomer. By employing these components in the polymer composition (optionally at the concentrations and ratios disclosed herein), a polyamide composition that demonstrates improved chemical resistance and moisture uptake characteristics is provided, for example, a polyamide composition demonstrating an improved chemical resistance to acids, bases, and various chemicals and/or a moisture uptake of less than about 2.0% by weight moisture at 95% relative humidity (RH). The polyamide compositions disclosed herein also demonstrate advantageous mechanical properties including a high tensile elongation, a high impact resistance as measured by notched Charpy impact energy loss at 23° C., a high tensile modulus, and a high abrasion resistance.

As disclosed herein, the use of dimer acids and/or dimer amines in polyamide compositions, e.g., (long chain and/or high temperature) polyamide compositions, surprisingly provides for materials that demonstrate both increased chemical resistance and reduced moisture uptake, while still maintaining strength and high temperature performance. Moreover, in some aspects, the chemical resistance and/or moisture uptake properties can synergistically improve together with the overall mechanical performance. In particular, the inventor has found that certain types, amounts, and ratios of dimer monomers can produce the compositions having surprising chemical resistance and reduced moisture uptake while maintaining mechanical and impact properties. Without being bound by theory, it is believed that the dimer monomers, e.g., dimer acids and dimer amines, work with the other components to synergistically meet application requirements which may include modulus, temperature resistance, impact resistance, chemical resistance, and/or dimensional stability.

The components of the polyamide composition are discussed individually. It is contemplated that these components may be employed with one another to form the aforementioned polyamide compositions.

### Polyamide Polymers

In one embodiment, the disclosed compositions comprise an aliphatic polyamide. The compositions disclosed herein include aliphatic polyamide and do not contain semi-aromatic polyamides, aromatic polyamides, or cyclic polyamides.

In one embodiment, the aliphatic polyamide comprises a first monomer having from 10 to 14 carbon atoms and a second monomer having 6 carbon atoms. This allows the aliphatic polyamide to have 6 carbon atom component. In one embodiment, the first monomer may comprise diamine or diacid. The first monomer may be a diamine comprising decanoic diamine, undecanoic diamine, dodecanoic diamine, tridecanedioic diamine, tetradecanoic diamine, or combinations thereof. The first monomer may be a diacid comprising decanoic diacid, undecanoic diacid, dodecanoic diacid, tridecanedioic diacid, tetradecanoic diacid, or combinations thereof. The second monomer may comprise diacid or diamine. In one embodiment, the second monomer may be a diacid comprising adipic acid or hexamethylene diamine.

In one embodiment, the second monomer may comprise diacid or diamine. In particular, when the first monomer is a diacid it is preferred that the second monomer is diamine. In a similar manner, when the first monomer is a diamine it is preferred that the second monomer is diacid.

The polyamide may comprise polyhexamethylene sebacamide (PA6/10), PA6/11, polyhexamethylene dodecanediamde (PA6/12), PA6/13, PA6/14, PA10/6, PA11/6, PA12/6, PA13/6, PA14/6 or combinations thereof. Preferably, the polyamide may comprise PA6/10, PA6/12, PA12/6, or combinations thereof.

Polyamides of the present disclosure include aliphatic polyamides. For purposes of the present invention, semi-aromatic or aromatic polyamide are not used. Aliphatic polyamides are preferably formed from condensation of the diamines and diacids.

In some embodiments, the polyamide compositions include polyamides produced through the ring-opening polymerization or polycondensation, including the copolymerization and/or copolycondensation, of lactams. These polyamides can include, for example, those produced from propriolactam, butyrolactam, valerolactam, and caprolactam. In some embodiments, the aliphatic polyamides herein disclosed are devoid or substantially devoid of polycaprolactam (PA6), e.g., contain less than 5% by weight, e.g., less than 3% by weight, less than 1% by weight, less than 0.5% by weight, less than 0.1% by weight, or no PA6 at all. In terms of ranges the polyamide compositions may comprise from 0 to 5% by weight of polyamides produced through the ring-opening polymerization or polycondensation, such as PA6, and more preferably from 0.01 to 3% by weight or from 0.05 to 1% by weight.

In certain aspects, the one or more polyamide polymers includes a polyamide 66 (PA6/6) that has high strength and stiffness at high temperatures and good impact strength at even low temperatures, conveying significant advantages for use in a wide array of applications seeking a balance of properties including strength, temperature resistance, toughness, as well as chemical resistance. Further, the high crystallinity coupled with a fast crystallization rate of PA6/6 polymer make the polyamide polymers including PA6/6 desirable for injection molding processes. In some embodiments, the aliphatic polyamides herein disclosed are devoid or substantially devoid of PA6/6, e.g., contain less than 5% by weight PA6/6, e.g., less than 3% by weight, less than 1% by weight, less than 0.5% by weight, less than 0.1% by weight, or no PA 6/6 at all. In terms of ranges the polyamide compositions may comprise from 0 to 5% by weight of polyamide 66 (PA6/6), and more preferably from 0.01 to 3% by weight or from 0.05 to 1% by weight.

The concentration of the aliphatic polyamides in the polyamide composition may range from 45% by weight to 95% by weight, e.g., from 45% by weight to 55 w %, from 50% by weight to 60% by weight, from 55% by weight to 65% by weight, from 60% by weight to 70% by weight, from 65% by weight to 75% by weight, from 70% by weight to 80% by weight, from 75% by weight to 85 w %, from 80% by weight to 90% by weight, from 85% by weight to 95% by weight, or any subranges thereof. In some embodiments, the aliphatic polyamides may range from 50% by weight to 85% by weight. In a preferred embodiment, the concentration of the aliphatic polyamides polymers ranges from 45% by weight to 65% by weight. In terms of upper limits, the aliphatic polyamide concentration may be less than 95% by weight, e.g., less than 90% by weight, less than 85% by weight, less than 80% by weight, less than 75% by weight, less than 70% by weight, less than 65% by weight, less than 60% by weight, less than 55% by weight, or less than 50% by weight. In terms of lower limits, the aliphatic polyamide concentration can be greater than 45% by weight, e.g., greater than 50% by weight, greater than 55% by weight, greater than 60% by weight, greater than 65% by weight, greater than 70% by weight, greater than 75% by weight, greater than 80% by weight, greater than 85% by weight, or greater than 90% by weight. Lower concentrations, e.g., less than 45% by weight, and higher concentrations, e.g., greater than 95% by weight, are also contemplated. These ranges and limits may be applicable to individual polyamides as well.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 45” may be interpreted as, and subsequently modified in the claims as “greater than or equal to 45.”

The polyamide composition can include a combination of aliphatic polyamides. By combining various aliphatic polyamides, the final composition can incorporate the desirable properties. The combination of polyamides could include any number of aliphatic polyamides described herein. In some embodiments, the polyamide composition includes a combination of any of the aliphatic polyamides previously described, preferably present in the amounts discussed herein. In one embodiment, the polyamide composition may comprise a combination of PA6/10 and PA6/12.

In some embodiments, the aliphatic polyamides have a melting temperature below 270° C., e.g., below 265° C., below 250° C., below 240° C., below 230° C., below 220° C., below 215° C. below 210° C., below 200° C., below 190° C., below 180° C., or below 175° C. The melting temperature of the aliphatic polyamides can each independently, for example, range from 165° C. to 270° C., e.g., from 165° C. to 220° C., from 170° C. to 215° C., from 175° C. to 215° C., from 180° C. to 215° C., from 185° C. to 225° C., from 205° C. to 245° C., from 225° C. to 265° C., or 240° C. to 270° C. In terms of lower limits, the melting temperature of each of the aliphatic polyamides can be greater than 165° C., e.g., greater than 170° C., greater than 175° C., greater than 185° C., greater than 195° C., greater than 205° C., greater than 215° C., greater than 225° C., greater than 235° C., greater than 245° C., or greater than 255° C. Higher melting temperatures, e.g., greater than 265° C., and lower melting temperatures, e.g., less than 165° C., are also contemplated.

In one embodiment, the polyamide composition is an aliphatic polyamide comprising a dimer monomer. A dimer monomer may comprise a dimer acid monomer or a dimer amine monomer.

PA 6/12 including dimer acid and/or dimer amine may have a ratio of 6/12 that is about 50/50. The polyamide composition can also include combinations of any of the polymers in a range from 0% by weight to 100% by weight, e.g., from 0% by weight to 60% by weight, from 10% by weight to 70% by weight, from 20% by weight to 80% by weight, from 30% by weight to 90% by weight, or from 40% by weight to 100% by weight, as described herein.

The melting temperatures of the polyamide compositions including the dimer monomer, a dimer acid or a dimer amine or a combination thereof, may range from 165° C. to 270° C. In some embodiments, a polyamide composition including PA6/12 and a dimer monomer as described herein has a melting temperature in a range from 165° C. to 270° C. In other embodiments, e.g. a polyamide composition including PA6/10 and a dimer monomer has a melting temperature in a range from 165° C. to 270° C. In yet other embodiments, e.g. a polyamide composition including PA6/6 and a dimer monomer has a melting temperature in a range from 240° C. to 270° C.

In some embodiments, one or more low crystallization temperature polyamides are utilized, e.g., a polyamide having a crystallization temperature below 250° C., below 240° C., below 230° C., below 220° C., below 210° C., below 200° C., below 190° C., below 180° C., or below 175° C. The crystallization temperature of the one or more polyamides can each independently, for example, range from 100° C. to 240° C., e.g., from 110° C. to 230° C., from 110° C. to 200° C., from 110° C. to 190° C., from 110° C. to 180° C., from 150° C. to 230° C., from 160° C. to 230° C., or from 170° C. to 230° C. In terms of lower limits, the crystallization temperature of each of the polyamides can be greater than 100° C., e.g., greater than 110° C., greater than 120° C., greater than 130° C., greater than 140° C., greater than 150° C., greater than 160° C., or greater than 170° C. Higher crystallization temperatures, e.g., greater than 250° C., and lower crystallization temperatures, e.g., less than 100° C., are also contemplated. The one or more low crystallization temperature polyamides can have a range from 110° C. to 180° C., e.g., for PA6/10 and/or PA6/12, or from 170° C. to 230° C., e.g., for PA6/6.

In some embodiments, each of the one or more polyamide polymers is crystalline or semi-crystalline. In some embodiments, each of the one or more polyamide polymers is crystalline. In some embodiments, each of the one or more polyamide polymers is semi-crystalline.

In some embodiments, polyamide compositions herein includes a single dimer monomer, e.g., dimer amine or dimer acid as described herein. In some embodiments, polyamides include no greater than one dimer monomer, wherein the dimer monomer is a dimer acid or a dimer amine. The level of crystallinity may also be affected by having a single dimer monomer as compared with providing two dimer monomers in the polyamide composition. For example, utilizing one dimer monomer can maintain a higher level of crystallinity, as well as other advantageous properties suitable for tubing, such as beneficial chemical resistance, dimensional stability, and gas barrier properties.

The polyamide composition of the present disclosure may include a dimer monomer. The dimer monomer of the present disclosure can include a dimer acid, or a dimer amine, or a combination thereof. In one embodiment, combinations of a single dimer acid and a single dimer amine may be utilized in the polyamide composition.

A dimer acid may be a dicarboxylic acid. In some cases, dimer acids, or dimerized fatty acids, are dicarboxylic acids prepared by dimerizing unsaturated fatty acids obtained from tall oil, usually on clay catalysts. Dimer acids can include chemical intermediates made by dimerizing unsaturated fatty acids (e.g., oleic acid, linoleic acid, linolenic acid, ricinoleic acid) in the presence of a catalyst, such as a bentonite or montmorillonite clay. Commercially available dimer fatty acids are usually mixtures of products in which the dimerized product predominates. Some commercial dimer acids are made by dimerizing tall oil fatty acids. Dimer fatty acids may have 36 carbons and two carboxylic acid groups. They may be saturated or unsaturated. The dimer acids or dimer amines are, in some cases, hydrogenated to remove unsaturation for better performance.

Example dimer fatty acids include dimerized oleic acid, trimerized oleic acid, dimerized linoleic acid, trimerized linolelic acid, dimerized linolenic acid, trimerized linolenic acid, or mixtures thereof. In some cases, the dimer acid may be predominantly a dimer of stearic acid, such as a C₃₆ dimer acid. The polyamide polymer of the present disclosure can include one or more dimer acids of the systems, for example, containing at least 18, preferably from 18 to 44, carbons, ranging from C₁₈ (including 18 carbons) to C₄₄ (including 44 carbons), e.g., from C₁₈ to C₄₀, from C₂₀ to C₃₈, or from C₂₂ to C₃₆. In terms of upper limits, the polyamide polymer can include one or more dimer acids of a C₄₄ system or less carbon atoms in the chain, e.g., C₄₄ dimer acids, C₄₂ dimer acids, C₄₀ dimer acids, C₃₈ dimer acids, or C₃₆ dimer acids. In terms of lower limits, the polyamide polymer can include one or more dimer acids of a C₁₈ system or greater carbon atoms in the chain, e.g., C₁₃ dimer acids, C₂₀ dimer acids, C₂₂ dimer acids, C₂₄ dimer acids, C₂₆ dimer acids, C₂₈ dimer acids, C₃₀ dimer acids, C₃₂ dimer acids, or C₃₄ dimer acids. Higher carbon dimer acids, e.g., greater than C₄₄, and lower carbon dimer acids, e.g., less than C₁₈, are also contemplated.

Dimer acids can be converted to dimer amines by reaction with ammonia and subsequent reduction, and can be an amine or amine derivative of a hydrocarbon-soluble polymerized fatty acid, particularly the class of dimer amines derived from dicarboxylic acids containing at least 12 carbon atoms, preferably from 19 to 60 carbon atoms. The polyamide composition can include one or more dimer acids and/or dimer amines, as in non-limiting examples, such as a C₃₆-unsaturated hydrogenated dimer acid such as PRIPOL™ 1009 having a molecular weight of about 570 g/mol and/or a dimer amine such as C₃₆ PRIAMINE™ 1074 or PRIAMINE™ 1075 having a molecular weight of about 540 g/mol (each available from Croda Inc., USA).

Using a dimer acid and/or a dimer amine has been found to provide tailorable functionality to the overall polyamide composition while maintaining original, desired functionality of the polyamides described above. To attain desired properties a single dimer acid or a single dimer amine can be utilized in the polyamide composition. In some embodiments, the polyamide composition includes a single dimer acid. In some embodiments, the polyamide composition includes a single dimer amine. In other embodiments, the polyamide composition includes at least one dimer acid or at least one dimer amine or a combination thereof.

The polyamide composition may comprise a dimer monomer having a concentration for example within the range from 5% by weight to 55% by weight, e.g., from 5% by weight to 10% by weight, from 15% by weight to 20% by weight, from 20% by weight to 30% by weight, from 25% by weight to 35% by weight, from 30% by weight to 40% by weight, from 15% by weight to 50% by weight, from 20% by weight to 45% by weight, 35% by weight to 55% by weight, from 35% by weight to 45% by weight, from 40% by weight to 50% by weight, from 45% by weight to 55% by weight, or any subranges thereof. In terms of upper limits, the dimer monomer concentration can be less than 55% by weight, e.g., less than 50% by weight, less than 45% by weight, less than 40% by weight, less than 35% by weight, less than 30% by weight, less than 25% by weight, less than 20% by weight, less than 15% by weight, or less than 10% by weight. In terms of lower limits, the combined polyamide polymer concentration can be greater than 5% by weight, e.g., greater than 10% by weight, greater than 15% by weight, greater than 20% by weight, greater than 25% by weight, greater than 30% by weight, greater than 35% by weight, greater than 40% by weight, greater than 45% by weight, or greater than 50% by weight. Lower concentrations, e.g., less than 5% by weight, and higher concentrations, e.g., greater than 55% by weight, are also contemplated.

In certain embodiments, the polyamide composition includes one or more of the Formulas (A) & (B) below:

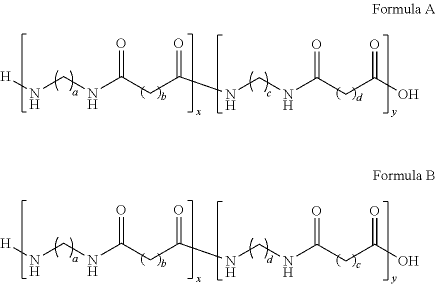

In the above Formulas (A) and (B), X+Y=100% by weight for the copolymers. In the above Formulas (A) and (B), a, b, c, d, are from 4 to 44, provided that a is 6 or less, then b is from 10 to 14 orb is 6 or less, then a is from 10 to 14; or c is 14 or less, then d is from 16 to 44. In one preferred embodiment, a is 4 or a is from 10 to 14, and b is 6 or b is from 10 to 14; c is 4 or 6 and d is from 18 to 36. In other embodiments, four separate monomers (2 acids and 2 amines) are used resulting in tetrapolymers. Alternatively, in yet other embodiments, formulations can include dimer amine and dimer acid in the same polymer.

In some embodiments, the polyamide composition contains AA-BB type polyamides. In some embodiments, the polyamide composition contains 5 to 55% by weight of the dimer acid and/or dimer amine repeating units and 45 to 95% by weight of AA-BB repeating units. The polyamide composition can, for example, contain dimer acid and/or dimer amine repeating units in a range from 20% by weight to 55% by weight, e.g., from 25% by weight to 55% by weight, from 30% by weight to 55% by weight, from 30% by weight to 50% by weight, from 30% by weight to 45% by weight, from 35% by weight to 42% by weight, or any subranges thereof. In terms of upper limits, the polyamide composition can, for example, contain dimer acid and/or dimer amine repeating units in an amount being less than 55% by weight, e.g., less than 50% by weight, less than 45% by weight, less than 42% by weight, less than 40% by weight, or less than 30% by weight. In terms of lower limits, the polyamide composition can, for example, contain dimer acid and/or dimer amine repeating units in an amount greater than 25% by weight, e.g., greater than 27% by weight, greater than 30% by weight, greater than 32% by weight, greater than 35% by weight, or greater than 37% by weight. Having less than 20% by weight of dimer acid and/or dimer amine repeating units tends to reduce the elongation. Higher amounts of dimer acid and/or dimer amine repeating units, e.g., greater than 55% by weight, are also contemplated for some embodiments.

The polyamide composition can, for example, can contain AA-BB repeating units in a range from, for example, 45 to 95% by weight, e.g., from 45% by weight to 55% by weight, from 50% by weight to 60% by weight, from 55% by weight to 65% by weight, from 60% by weight to 70% by weight, from 65% by weight to 75% by weight, from 70% by weight to 80% by weight, from 75% by weight to 85% by weight, from 80% by weight to 90% by weight, from 85% by weight to 95% by weight, or any subranges thereof. In terms of upper limits, the polyamide composition can, for example, contain AA-BB repeating units in an amount be less than 95% by weight, e.g., less than 90% by weight, less than 85% by weight, less than 80% by weight, less than 75% by weight, less than 70% by weight, less than 65% by weight, less than 60% by weight, less than 55% by weight, or less than 50% by weight. In terms of lower limits, the polyamide composition can, for example, contain AA-BB repeating units in an amount greater than 45% by weight, e.g., greater than 50% by weight, greater than 55% by weight, greater than 60% by weight, greater than 65% by weight, greater than 70% by weight, greater than 75% by weight, greater than 80% by weight, greater than 85% by weight, or greater than 90% by weight. Lower amounts of AA-BB repeating units, e.g., less than 45% by weight, and higher amounts, e.g., greater than 95% by weight, are also contemplated.

The AA-BB repeating unit may be selected from the product prepared from a dicarboxylic acid and a diamine and includes, but is not limited to PA6/10; PA6/12; PA 10/6.

The molecular structure of PA6/12-hydrogenated dimer acid and PA6/12-hydrogenated hydrogenated dimer amine are shown in Formulas (A) and (B), respectively, below.

The number average molecular weight (Mn) of the one or more polyamide polymers in the polyamide composition can each independently, for example, range from 9,000 g/mol to 60,000 g/mol, e.g., from 9,000 g/mol to 12,000 g/mol, from 9,000 g/mol to 15,000 g/mol, from 9,000 g/mol to 20,000 g/mol, from 9,000 g/molto 24,000 g/mol, from 9,000 g/mol to 25,000 g/mol, from 9,000 g/mol to 45,000 g/mol, from 10,000 g/mol to 20,000 g/mol, from 10,000 g/mol to 25,000 g/mol, from 10,000 g/mol to 30,000 g/mol, from 10,000 g/mol to 45,000 g/mol, from 12,000 g/mol to 20,000 g/mol, from 12,000 g/mol to 45,000 g/mol, from 13,000 g/mol to 18,000 g/mol, from 13,000 g/mol to 25,000 g/mol, from 15,000 g/mol to 30,000 g/mol, from 20,000 g/mol to 25,000 g/mol, from 20,000 g/mol to 35,000 g/mol, from 20,000 g/mol to 45,000 g/mol, from 30,000 g/mol to 45,000 g/mol, from 35,000 g/mol to 50,000 g/mol, from 40,000 g/mol to 55,000 g/mol, or from 45,000 g/molto 60,000 g/mol. In some embodiments, an injection molded article comprising any of the provided polyamide compositions is provided, where the number average molecular weight can be from 9,000 g/mol to 20,000 g/mol. In other embodiments, an extruded article of any of the provided polyamide compositions is provided and can be a profile extrusion article, a monofilament, a fiber, where the number average molecular weight can be from 20,000 g/mol to 45,000 g/mol.

In terms of upper limits, the one or more polyamide polymers can have a number average molecular weight less than 60,000 g/mol, e.g., less than 55,000 g/mol, less than 50,000 g/mol, less than 45,000 g/mol, less than 40,000 g/mol, less than 35,000 g/mol, less than 30,000 g/mol, less than 25,000 g/mol, less than 24,000 g/mol, less than 20,000 g/mol, less than 18,000 g/mol, less than 15,000 g/mol, less than 12,000 g/mol, or less than 10,000 g/mol. In terms of lower limits, the one or more polyamide polymers can have a number average molecular weight greater than 9,000 g/mol, e.g., greater than 10,000 g/mol, greater than 12,000 g/mol, greater than 13,000 g/mol, greater than 15,000 g/mol, greater than 20,000 g/mol, greater than 25,000 g/mol, greater than 30,000 g/mol, greater than 35,000 g/mol, greater than 40,000 g/mol, greater than 45,000 g/mol, greater than 50,000 g/mol, or greater than 55,000 g/mol. Higher molecular weights, e.g., greater than 60,000 g/mol, and smaller molecular weights, e.g., less than 9,000 g/mol, are also contemplated.

The one or more polyamides each independently have a specific configuration of end groups, such as, amine end groups, carboxylate end groups and so-called inert end groups including mono-carboxylic acids, mono-amines, lower dicarboxylic acids capable of forming inert imine end groups, phthalic acids and derivatives thereof. It has been found that in some aspects, the polymer end groups can be selected to specifically interact with the dimer monomer of the composition, affecting dispersion and resulting in mechanical properties changes. The polyamide polymer of the present disclosure can have an amine end group content, for example, ranging from 10 μeq/g to 110 μeq/g, e.g., from 20 μeq/g to 100 μeq/g, from 30 μeq/g to 90 μeq/g, or from 35 μeq/g to 80 μeq/g. In terms of upper limits, the polyamide polymer can have an amine end group content of less than 110 μeq/g, e.g., less than 100 μeq/g, less than 90 μeq/g, or less than 85 μeq/g. In terms of lower limits, the polyamide polymer can have an amine end group content of greater than 10 μeq/g, e.g., greater than 20 μeq/g, greater than 25 μeq/g, or greater than 30 μeq/g. In some embodiments wherein the number average molecular weight of the one or more polyamides is high, preferably greater than about 30,000 g/mol, there can be lower concentrations of amine end groups. Generally, as the number average molecular weight increases, the amine end group content decreases.

The viscosity number, e.g., for polyamides comprising a first monomer having 10 to 14 carbon atoms, a second monomer having 6 carbon atoms and those polyamide comprising a dimer monomer, may be sufficient for processing. Additives such as flame retardants may have effect on the viscosity number. In one embodiment, the viscosity number may be greater than 95 cm³/g (in meta-cresol), e.g., greater than 100 cm³/g, greater than 105 cm³/g, greater than 110 cm³/g, greater than 115 cm³/g, greater than 120 cm³/g, or greater than 125 cm³/g. In terms of ranges, the viscosity number of the polyamide is preferably from 95 to 250 cm³/g, e.g., from 100 to 250 cm³/g, from 100 to 225 cm³/g, from 100 to 200 cm³/g, from 100 to 195 cm³/g, or from 105 to 190 cm³/g, or from 110 to 185 cm³/g. When the viscosity number is less than 95 cm³/g the mechanical properties of the article may deteriorate. When the viscosity number exceeds 250 cm³/g the processing during extrusion may be affected.

The polyamide composition have an initial elongation (tensile) at break that is greater than 100%, e.g., greater than 105%, greater than 125%, greater than 150%, greater than 175%, greater than 200%, greater than 225%, or greater than 250%. The initial elongation (tensile) at break refers to the elongation prior to adding flame retardants, plasticizers and other additives described herein. In one embodiment, the initial elongation (tensile) at break may range from 100% to 350%, e.g., from 100% to 300%, from 100% to 275%, from 105% to 250%, from 105% to 225%, from 110% to 215%, from 110% to 210%, from 125% to 200%, or from 150% to 195%. While the upper limit is not necessary, the polyamide having initial elongation (tensile) at break of less than 350% have been found to be easy to process. In one preferred embodiment, the initial elongation (tensile) at break may be less than less than 325%, e.g., less than 300%, less than 275%, less than 250%, less than 225%, less than 200%, less than 175%, less than 150%, less than 125%. The elongation at break of the polyamide composition can be measured using a standard protocol such as ISO 527-1 (2019).

The polyamide composition including the dimer monomer, a dimer acid or a dimer amine or a combination thereof, may have a dimer concentration as measured by methylene/amide ratios. The methylene/amide ratio is believed to be important because by making the backbone more aliphatic with more CH₂ (methylene) groups between the amides, the resulting chains have much greater flexibility due to the free range of motion they exhibit as they are not confined by the amide linkage; in other words, Brownian motion of the chains increases as the amide functionality decreases. Additionally, the methylene groups are hydrophobic and do not associate with water.

Further, the methylene/amide ratios can be tailored so that the polyamide compositions can handle either very basic or very acidic environments to provide the best chemical resistance in a particular environment. Hence, the more dilute the methylene/amide ratios become, the lower the potential for moisture uptake. By combining the polyamide polymer with the dimer acid and/or the dimer amine, the methylene/amide ratio is manipulated. By increasing the methylene/amide ratio, it is believed that resulting polyamide compositions may achieve increased flexibility and chemical resistance, while reducing moisture uptake. The polyamide composition can, for example, have a methylene/amide ratio range from 6:1 to 15:1, e.g., from 6:1 to 9:1, from 6:1 to 12:1, from 9:1 to 12:1, from 9:1 to 15:1, or from 12:1 to 15:1. The polyamide composition having a methylene/amide ratio ranging from 6:1 to 15:1 can be, for example, PA6/6 or PA6/12. This may be explained and calculated from the backbone structure. In the case of PA6/6, there are two amide linkages and 12 carbons in each repeat unit, providing a ratio of 12/2 or 6:1. In the case of PA6/12, there are two amide linkages and 18 carbons in each repeat unit, providing a ratio of 18/2 or 9:1. In an embodiment having a PA6/12-s-PA6/36 system, the methylene/amide ratio can be calculated via the mol % of each component. For example, in the case of a composition comprising a ratio of 75:25 of PA6/12 and PA6/36, the methylene/amide ratio may be 12:1.

PA6/6 has a methylene/amide ratio of about 6:1 or greater. In some embodiments, the polyamide composition has a methylene/amide ratio ranging from 9:1 to 15:1. The polyamide composition can be PA6/12 having a methylene/amide ratio ranging from about 9:1 or greater. The inventor has surprisingly found, for example, a polyamide composition including PA6/12 with a dimer monomer content of up to about 45% by weight may result in the methylene/amide ratio increasing from 9:1 (without monomer) to 12:1. Any of the polyamide polymers disclosed herein may be used and can have a methylene/amide ratio of from 6:1 to 15:1. As the amount of dimer acid and/or dimer amine is increased, the methylene/amide ratio is also increased. The increase in methylene/amide ratio yields advantages, such as increased chemical resistance, reduced moisture uptake, increased mechanical properties (elongation, impact resilience, abrasion resistance), better clarity, UV resistance, and others.

### Flame Retardant

In one embodiment, the polyamide composition disclosed herein comprises a flame retardant. Adding the flame retardants to the polyamide compositions demonstrate good flame retardancy effect (V-2 or V-0 and/or GWFI/GWIT) in combination with improved flowability, high thermal stability, and high impact toughness, while maintaining elongation. The polyamide compositions with the flame retardants exhibit slight discoloration upon melt processing. In particular, the polyamide compositions disclosed herein have very good fire protection, and in particular, the polyamide compositions preferably have a UL94 fire classification of V-2, or more preferably have a UL94 fire classification of V-0.

Preferably, the polyamide composition comprises one or more non-halogenated flame retardants. The polyamide composition can, for example, contains non-halogenated flame retardants in a range from 3% by weight to 40% by weight, e.g., from 3.5% by weight to 35% by weight, from 4% by weight to 30% by weight, from 5% by weight to 32% by weight, from 5% by weight to 30% by weight, from 5 to 25% by weight or from 5 to 20% by weight, including any subranges thereof. In one embodiment, the polyamide composition may comprise from 3% by weight to 18% by weight of one or more non-halogenated flame retardants. In terms of upper limits, the non-halogenated flame retardants may be less than 40% by weight, e.g., less than 35% by weight, less than 30% by weight, less than 25% by weight, less than 20% by weight, or less than 15% by weight. In terms of lower limits, to achieve sufficient thermal protection, the non-halogenated flame retardants may be greater than 3% by weight, e.g., greater than 3.5% by weight, greater than 4% by weight, greater than 4.5% by weight, or greater than 5% by weight.

In one embodiment, the one or more non-halogenated flame retardants may also be free from metals, such as but not limited to copper, aluminum, boron, zinc, or lead.

The flame retardants for the polyamide composition disclosed herein may include phosphorous-containing flame retardants, nitrogen-containing flame retardants and combinations thereof. Phosphorous-containing flame retardants may include phosphazenes, polyphosphates, polyphosphonates, aryl phosphates, organophosphates, diphosphates, or combinations thereof. Flame retardants with low content of phosphorous-containing flame retardants may be used to prepare polyamide compositions with improved performance. Nitrogen-containing flame retardants may include triazines, hindered amines, or combinations thereof. Flame retardants with low content of nitrogen-containing flame retardants may be used to prepare polyamide compositions with improved performance.

In particular, the flame retardants may include a combination of phosphazenes and diphosphonates. In another embodiment, the flame retardants may include a combination of phosphazenes and triazines. In another embodiment, the flame retardants may include a combination of polyphosphate and triazines. In yet another embodiment, the flame retardants may include a combination of polyphosphate and hindered amines.

Phosphazenes may provide flame retardancy to the polyamide composition. In one embodiment, phosphazenes may be used alone or in combination with another flame retardant.

Preferably, the phosphazenes contain no halogen atom. In one embodiment, the phosphazene is a cyclic phenoxyphosphazene, linear phenoxy phosphazene, or phenoxy phosphazene. Particularly preferred are cyclic phenoxyphosphazenes of the formula (Formula C) P₃N₃C₃₆:

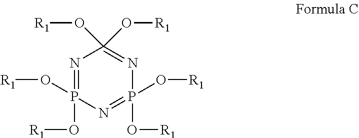

where each R₁ is the same or different and is a hydrogen atom, C₁₋₂₀-alkyl, C₆₋₃₀-aryl, C₆₋₃₀-arylalkyl or C₆₋₃₀-alkyl substituted aryl. In one preferred embodiment, R₁ is a C₆₋₃₀-aryl.

In one embodiment, the phosphazene compound may be represented by the formula (D) or (E).

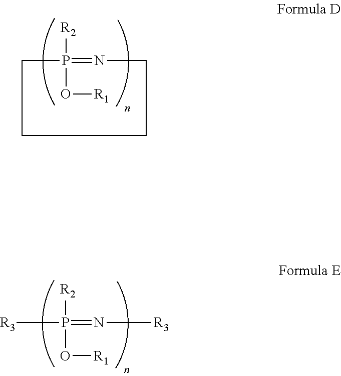

where R₁ is a hydrogen atom, C₁₋₂₀-alkyl, C₆₋₃₀-aryl, C₆₋₃₀-arylalkyl or C₆₋₃₀-alkyl substituted aryl;
R₂ is a hydrogen atom, oxygen group, hydroxyl group, amino group, an —O—R₁ group, C₁₋₂₀-alkyl, C₆₋₃₀-aryl, C₆₋₃₀-arylalkyl or C₆₋₃₀-alkyl substituted aryl;
each R₃ is the same or different and is —N═P(O—R₁)₃, —N═P(O)O—R₁, —P(O—R₁)₄, —P(O)(O—R₁)₂, C₁₋₂₀-alkyl, C₆₋₃₀-aryl, C₆₋₃₀-arylalkyl or C₆₋₃₀-alkyl substituted aryl; and
n is an integer of 3 to 1000, preferably of 3 to 100 or more preferably 3 to 25.

In one embodiment, the phosphazene may include hexaphenoxycyclotriphosphazene (HPTCP), octaphenoxycyclotetraphosphazene (OPTCP), or decaphenoxycyclopentaphosphazene (DPCPP). Commercially available cyclic phosphazenes include Rablite™ FP-110 (Fushimi Pharmaceutical) and SPS100 (Otsuka Chemical Co., Ltd.).

Polyphosphates are phosphorous-containing flame retardants that provide flame retardancy to the polyamide compositions. Polyphosphonates may have higher molecular weight (greater than 10,000 mol/g) that reduced migration from polyamide composition. This can provide advantages for long-term use and may allow the polyphosphonates to be embedded, and more preferably permanently embedded, in the polymer matrix. Preferably, the polyphosphonates do not contain a metal atom or halogen atom.

In one embodiment, the polyphosphates compound may be represented by the formula (F):

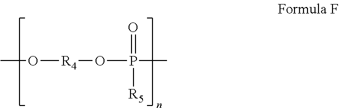

where R₄ is a substituted or unsubstituted C₆₋₃₀-aryl or C₆₋₃₀-arylalkyl;
R₅ is a C₁₋₂₀-alkyl, C₂₋₂₀-alkene, C₂₋₂₀-alkyne, C₅₋₂₀-cycloalkyl, or C₆₋₂₀-aryl, or C₆₋₂₀-arylalkyl, and preferably R₅ is a C₁₋₆ alkyl; and
n is from 2 to 200, preferably from 2 to 100.

In one embodiment, R₄ is an aromatic group that may be derived from, having one or more optionally substituted, aryl rings such as, but not limited to, resorcinols, hydroquinones, and bisphenols, such as bisphenol A, bisphenol F, and 4,4′-biphenol, phenolphthalein and its derivatives, 4,4′-thiodiphenol, 4,4′-sulfonyldiphenol, or combinations thereof.

Commercially available polyphosphonates have from 10% by weight phosphorous to 12% by weight phosphorous. Commercially available polyphosphonates include Nofia™ HM1100, HM5000, HM7000, and HM9000 (FRX polymers).

Aryl phosphates may provide flame retardancy to the polyamide composition. In one embodiment, aryl phosphates may be used alone or in combination with another flame retardant. Preferably, the aryl phosphates contain no halogen atom. Low volatility of aryl phosphates when processing polyamide composition is desirable. In one embodiment, the aryl phosphates may be represented by the formula (G):

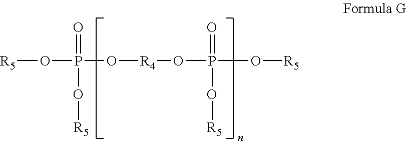

where R₄ is a substituted or unsubstituted C₆₋₃₀-aryl or C₆₋₃₀-arylalkyl;
R₅ are each independently a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₆₋₂₀-aryl, or C₆₋₂₀-arylalkyl; and
n is from 1 to 5.

The aryl phosphates may be blended with the polyamide as a liquid or solid.

Commercially available aryl phosphates include resorcinol bis(diphenyl phosphate) under the brand name Fyroflex™ RDP or Fyroflex™ Sol-DP (ICL Industrial Products).

Diphosphonates are phosphorous-containing flame retardants that provide flame retardancy to the polyamide composition. In one embodiment, the diphosphonates may be used alone or in combination with another flame retardant. Preferably, the diphosphonates do not contain a metal or halogen atom. In one embodiment, the diphosphonate compound may be represented by the formula (H):

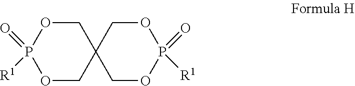

where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

Examples of diphosphonates include dimethyl pentaerythritol diphosphonate, dibenzyl pentaerythritol diphosphonate, diphenyl pentaerythritol diphosphonate and dinaphthyl pentaerythritol diphosphonate.

Commercially available diphosphonate includes cyclic diphosphonate under the brand name AFLAMMIT™ PCO 900 (THOR GmbH), which is 3,9-Dimethyl-2,4,8,10-tetraoxa-3,9-diphosphaspiro[5.5]undecane-3,9-dioxide.

Triazines and hindered amines are nitrogen-containing flame retardants that provide flame retardancy to the polyamide composition. In one embodiment, the nitrogen-containing flame retardant may be used alone or in combination with another flame retardant. Preferably, the nitrogen-containing flame retardants do not contain a metal or halogen atom.

The nitrogen-containing flame retardants may include triazines or N-alkoxyamines. Triazines may include melamine phosphates, melamine cyanurates, or combinations thereof. Melamine phosphates include melamine phosphate, dimelamine phosphate, melamine pyrophosphate, melamine polyphosphates, melam polyphosphates, melam polyphosphates, melamine condensation products, or mixtures thereof. Melanmine cyanurates may be understood to include melamine condensation products such as a melem, melam, melon or combinations thereof. Preferably, the triazine includes melanmine cyanurates that are added in powder form.

Cyanurates may include melamine cyanurate, and isocyanurate. In particular, 1,3,5-trihydroxyethyl isocyanurate, 1,3,5-triglycidyl isocyanurate or triallyl isocyanurate may be used as flame retardants.

Hindered amines may include 1-cyclohexyloxy-2,2,6,6-tetramethyl-4-octadecylaminopiperidine; bis(1-octyloxy-2,2,6,6-tetramethylpiperidin-4-yl)sebacate; 2,4-bis[(1-cyclohexyloxy-2,2,6,6-tetramethylpiperidin-4-yl)butylamino]-6-(2-hydroxyethylamino-s-triazine; bis(1-cyclohexyloxy-2,2,6,6-tetramethylpiperidin-4-yl)adipate; 2,4-bis[(1-cyclohexyloxy-2,2,6,6-tetramethylpiperidin-4-yl)butylamino]-6-chloro-s-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methylpropoxy)-4-octadecanoyloxy-2,2,6,6-tetramethylpiperidine; bis(1-(2-hydroxy-2-methylpropoxy)-2,2,6,6-tetramethylpiperidin-4-yl)sebacate; bis(1-(2-hydroxy-2-methylpropoxy)-2,2,6,6-tetramethylpiperidin-4-yl)adipate; 2,4-bis{N-[1-(2-hydroxy-2-methylpropoxy)-2,2,6,6-tetramethylpiperidin-4-yl]-N-butylamino}-6-(2-hydroxyethylamino)-s-triazine; the reaction product of 2,4-bis[(1-cyclohexyloxy-2,2,6,6-tetramethylpiperidin-4-yl)-butylamino]-6-chloro-s-triazine with N,N′-bis(3-aminopropyl)ethylenediamine); 2,4-bis[(1-cyclohexyloxy-2,2,6,6-tetramethylpiperidin-4-yl)butylamino]-6-(2-hydroxyethylamino-s-triazine; or the oligomeric compound which is the condensation product of 4,4′-hexamethylene-bis(amino-2,2,6,6-tetramethylpiperidine) and 2,4-dichloro-6-[(1-cyclohexyloxy-2,2,6,6-tetramethylpiperidin-4-yl)butylamino]-s-triazine end-capped with 2-chloro-4,6-bis(dibutylamino)-s-triazine.

In one embodiment, the flame retardants may include a polyalcohol. Polyalcohols may be useful to provide flame retardancy by providing an insulating char deposit. In one embodiment, the polyalcohol may include pentaerythritol, dipentaerythritol, tripentaerythritol, or combinations thereof. In a preferred embodiment, the polyalcohol may be dipentaerythritol.

The flame retardant may include polyalcohol in a range from 0.5% by weight to 10% by weight, e.g., from 1% by weight to 10% by weight, from 1% by weight to 8.5% by weight, from 2% by weight to 8% by weight, from 3% by weight to 7% by weight, from 3.5 to 5.5% by weight or from 4.5 to 5% by weight, including any subranges thereof. In terms of upper limits, the polyalcohol may be less than 10% by weight, e.g., less than 9% by weight, less than 8% by weight, less than 7% by weight, less than 6% by weight, or less than 5% by weight. In terms of lower limits, the polyalcohol may be greater than 0.5% by weight, e.g., greater than 1% by weight, greater than 1.5% by weight, greater than 2% by weight, greater than 2.5% by weight, greater than 3% by weight, greater than 3.5% by weight, greater than 4% by weight, or greater than 4.5% by weight.

### Lubricant

In one embodiment, the polyamide composition may include one or more lubricants. The type and relative amount of lubricants can be selected to improve processing of the composition, and to contribute to the simultaneously high strength and ductility of the material. The concentration of lubricant in the polyamide composition can, for example, range from 0% by weight to 5% by weight, e.g., from 0.1% by weight to 5% by weight, from 0.1% by weight to 4.5% by weight, from 0.1% by weight to 4% by weight, from 0.25% by weight to 3.5% by weight, from 0.25% by weight to 2.5% by weight, from 0.5% by weight to 2.25% by weight, from 0.75% by weight to 2.0% by weight, or from 0.75% by weight to 1.75% by weight. In terms of upper limits, the lubricant concentration can be less than or equal to 5.0% by weight, e.g., less than 4.75% by weight, less than 4.5% by weight, less than 4.25% by weight, less than 4% by weight, less than 3.75% by weight, less than 3.5% by weight, less than 3.25% by weight, less than 3% by weight, less than 2.75% by weight, less than 2.5% by weight, less than 2.25% by weight, less than 2.0% by weight, or less than 1.75% by weight. In terms of lower limits, the lubricant concentration can be greater than or equal to 0% by weight, e.g., greater than 0.05% by weight, greater than 0.1% by weight, greater than 0.2% by weight, greater than 0.25% by weight, greater than 0.5% by weight, greater than 0.6% by weight, greater than 0.75% by weight, greater than 1.0% by weight, or greater than 1.25% by weight. Higher concentrations, e.g., greater than 2.0% by weight, are also contemplated.

In some embodiments, the lubricant comprises a saturated fatty acid. For example the lubricant may comprise stearic acid, behenic acid, or combinations thereof, or salts thereof. In some cases, the lubricant comprises a stearate. Preferably, the lubricant may be zinc stearate, calcium stearate, aluminum strearate, aluminum distearate, N,N′ ethylene bis-stearamide, stearyl erucamide, montan waxes, or combinations thereof. In some cases, the lubricant is a stearate combined with a wax, e.g., a saponified esterwax. A prilled form of N,N′ ethylene bis-stearamide wax may be used, which is commercially available as Acrawax™ C Prilled (Lonza). In some embodiments, the lubricant does not include an ionic lubricant.

In some embodiments, the lubricant may be a wax. In some embodiments, the lubricant consists of a wax. In some embodiments, the wax includes a fatty acid. In some embodiments, the lubricant consists of a fatty acid. In some embodiments, the wax includes a saturated fatty acid. In some embodiments, the lubricant consists of a saturated fatty acid. In some embodiments, the wax includes stearic acid, behenic acid, or salts or combinations thereof. In some embodiments, the wax consists of stearic acid, behenic acid, or salts or combinations thereof. In some embodiments, the wax is saponified ester wax. For example, suitable for polyamide compositions described herein may include Montan wax, which is a saponified ester wax including dimerized alkyl chains, having a molecular weight of about 824 g/mol.

In some cases, the wax is a saponified ester wax combined with a stearate. In some embodiments, the wax is a Montan wax and is further combined with a metal stearate, such as aluminum distearate or zinc stearate.

In some cases, the compositions employ waxes that have alkyl portions or tails are that are significantly longer than for stearates, e.g., 40% longer. For example, Montan waxes having C₂₈ portions are desirable in the polyamide compositions herein because the higher chain length makes them more efficacious lubricants for the longer chain polymers. In some embodiments, the lubricant includes a chain length greater than C₁₈, greater than C₂₀, greater than C₂₂, greater than C₂₄, greater than C₂₆, or greater than C₂₈. In some embodiments, a C₂₈ lubricant is employed in the polyamide compositions herein. Stearates, e.g., aluminum distearate, zinc stearate, calcium stearate, or combinations thereof, are not suitable for use alone, but may be suitable in combinations with another lubricant such as described above.

Specifically, the polyamide compositions, in some embodiments, do not include stearate waxes such as ethylenebisstearamide (EBS), commonly sold as Akrowax® having a molecular weight of about 593 g/mol and a C₁₃ chain length. Specifically, the polyamide compositions, in some embodiments, do not include stearic acid. In some embodiments, the polyamide compositions do not include stearyl erucamide. In some embodiments, the polyamide compositions do not include C₁₈ stearates.

In some embodiments, the polyamide compositions include a lubricant having a molecular weight range of, for example, from 600 g/mol to 1200 g/mol, e.g., from 600 g/mol to 800 g/mol, 800 g/mol to 1000 g/mol, or 1000 g/mol to 1200 g/mol. In terms of upper limits, the lubricant molecular weight can be less 1200 g/mol, e.g., less than 1100 g/mol, less than 1000 g/mol, less than 900 g/mol, less than 800 g/mol, or less than 700 g/mol. In terms of lower limits, the lubricant molecular weight can be greater than 600 g/mol, e.g., greater than 700 g/mol, greater than 800 g/mol, greater than 900 g/mol, greater than 1000 g/mol, or greater than 1100 g/mol. Lower molecular weights, e.g., less than 600 g/mol, and molecular weights, e.g., greater than 1200 g/mol are also contemplated. In some embodiments, the polyamide compositions herein disclosed are devoid or substantially devoid of lower molecular weight lubricants, e.g., having a molecular weight less than 800 g/mol, or less than 700 g/mol, or less than 600 g/mol, e.g., contain less than or equal to 5% by weight, e.g., less than 3% by weight, less than 1% by weight, less than 0.5% by weight, less than 0.1% by weight, or no lower molecular weight lubricants at all.

In addition to other performance improvements, the disclosed lubricants also significantly improve dispersion of the components in the matrix of the polymer.

The concentration of the lubricant, e.g., stearic acid or salt thereof, in the polyamide composition can, for example, range from 0.01% by weight to 0.7% by weight, e.g., from 0.01% by weight to 0.1% by weight, from 0.05% by weight to 0.2% by weight, from 0.1% by weight to 0.3% by weight, from 0.1% by weight to 0.6% by weight, from 0.2% by weight to 0.4% by weight, from 0.3% by weight to 0.5% by weight, from 0.4% by weight to 0.6% by weight, or from 0.5% by weight to 0.7% by weight. In terms of upper limits, the lubricant concentration can be less than 0.7% by weight, e.g., less than 0.6% by weight, less than 0.5% by weight, less than 0.4% by weight, less than 0.3% by weight, less than 0.2% by weight, less than 0.1% by weight, less than 0.05% by weight, less than 0.03% by weight, or less than 0.02% by weight. In terms of lower limits, the stearic acid or salt concentration can be greater than 0.01% by weight, e.g., greater than 0.02% by weight, greater than 0.03% by weight, greater than 0.05% by weight, greater than 0.1% by weight, greater than 0.2% by weight, greater than 0.3% by weight, greater than 0.4% by weight, greater than 0.5% by weight, or greater than 0.6% by weight. Higher concentrations, e.g., greater than 0.7% by weight, and lower concentrations, e.g., less than 0.01% by weight, are also contemplated. Suitable lubricants may be chosen from N,N′ ethylene bis-stearamide, stearyl erucamide, aluminum distearate, zinc stearate, montan waxes, or combinations thereof. In certain embodiments employing a combination of lubricants, for example, 0.3-0.4% by weight stearyl erucamide is mixed with 0.1-0.2% by weight aluminum or zinc stearate. Lower or higher amounts of lubricants can be used tailored to the application for use.

In some preferred embodiments, a stearate or a metal stearate, e.g., aluminum distearate and/or zinc stearate, is mixed with a saponified ester wax, e.g., Montan waxes, as lubricants.

In aspects, polyamide compositions herein include that lubricant is present in an amount greater than or equal to 0.1% by weight, e.g., greater than 0.2% by weight, or greater than 0.3% by weight. In the case of injection molding, lubricant amounts are preferably from about 0.3% by weight to about 0.6% by weight.

### Plasticizer

Adding plasticizer to the polyamide compositions described herein has a notable effect on the flow and thermal properties, e.g., decreasing the glass transition temperature (Tg), as well as elastic modulus of the resultant articles such as an extruded article, a profile extrusion article, a monofilament, or a fiber. In an exemplary embodiment, the polyamide compositions described herein may comprise a plasticizer. Plasticizers assist in increasing the flow of the compositions and provide toughness/increased elongation at break.

The plasticizer may be a non-polar plasticizer that is preferable non-volatile during the processing of the polyamide composition. In one embodiment, the plasticizer comprises an ester of glycols, esters of C₆ to C₂₀ aliphatic acids, esters of C₆ to C₂₀ aromatic acids, or combinations thereof. The aliphatic acids may include adipic acid, sebacic acid, The aromatic acids may include benzenoic acid, phthalic acid, sulfonic acid, or combinations thereof. Suitable plasticizers include triethylene glycol bis(2-ethylhexanoate), ethyl p-hydroxybenzoate, octyl p-hydroxybenzoate, i-hexadecyl p-hydroxybenzoate, n-octyl toluenesulfonic acid, n-butyl benzenesulfonic acid, 2-ethylhexylbenzene sulfonic acid, dibutyl adipate, dibutyl sebacate, dibutyl phthalate, dihexyl adipate, dihexyl sebacate, dihexyl phthalate, dicyclohexyl adipate, dicyclohexyl phthalate, dioctyl adipate, dioctyl sebacate, dioctyl phthalate, diisodecyl adipate, diisodecyl sebacate, diisodecyl phthalate, diundecyl adipate, diundecyl sebacate, diundecyl phthalate, didodecanyl adipate, didodecanyl sebacate, didodecanyl phthalate, diphenyl phthalate, diphenyl sebacate and diphenyl adipate.

In an exemplary embodiment, the plasticizer is diundecyl phthalate which is commercially available under several names, such as, Jayflex™ L11P (Exxon Mobil) and Palatinol® 111P (BASF). In an exemplary embodiment, the plasticizer is triethylene glycol bis(2-ethylhexanoate), which is commercially available as Celanese PLX Plasticizer (Celanese). In an exemplary embodiment, the plasticizer is di-octyladipate, which is commercially available as Plastomoll™ DOA (BASF).

The concentration of the plasticizer in the polyamide composition can, for example, range from 0.5% by weight to 10% by weight, e.g., from 0.5% by weight to 9.5% by weight, from 0.5% by weight to 7.5% by weight, from 0.75% by weight to 6% by weight, from 1% by weight to 5.5% by weight, from 1% by weight to 5% by weight, or from 1.5% by weight to 4.5% by weight. In terms of upper limits, the plasticizer concentration can be less than or equal to 10% by weight, e.g., less than 9.0% by weight, less than 8.0% by weight, less than 7.0% by weight, less than 6.0% by weight, less than 5.0% by weight, less than 4.5% by weight, or less than 4.0% by weight. In terms of lower limits, the plasticizer can be greater than 0.5% by weight, e.g., greater than 0.6% by weight, greater than 0.75% by weight, greater than 0.85% by weight, greater than 0.9% by weight, greater than 1% by weight, greater than 1.05% by weight, greater than 1.1% by weight, greater than 1.25% by weight, or greater than 1.5% by weight. Higher concentrations, e.g., greater than 10% by weight, and lower concentrations, e.g., less than 0.5% by weight, are also contemplated. In aspects, the concentration of plasticizers in the polyamide composition is present in an amount greater than 1.5% by weight.

### Other Additives

The polyamide composition can also include one or more other additives comprising antioxidants, other polymers, UV stabilizers, impact modifiers, hydrolysis stabilizers, nucleating agents, processing aids, chain terminators, viscosity modifiers, catalysts, delusterants, antimicrobial agents, antistatic agents, optical brighteners, extenders, mineral filler, and other commonly used additives known to those of skill in the art. Additional suitable additives may be found in Plastics Additives, An A-Z reference, Edited by Geoffrey Pritchard (1998). In some embodiments, there may be a stabilizer added to the polyamide composition. Stabilizers suitable for the additive dispersion include, but are not limited to, polyethoxylates (such as the polyethoxylated alkyl phenol Triton X-100), polypropoxylates, block copolymeric polyethers, long chain alcohols, alkylsulfates, alkyl-sulfonates, alkyl-benzenesulfonates, alkylphosphates, alkyl-phosphonates, alkyl-naphthalene sulfonates, carboxylic acids, and perfluoronates.

Some or all of these components may be considered optional. In some cases, the disclosed compositions may expressly exclude one or more of the aforementioned components, e.g., via claim language. For example claim language may be modified to recite that the disclosed compositions, processes, etc., do not utilize or comprise one or more of the aforementioned additives.

The concentration of the one or more other additives in the polyamide composition can, for example, range from 0% by weight to 20% by weight, e.g., from 0% by weight to 15% by weight, from 0.1% by weight to 15% by weight, from 0.1% by weight to 10% by weight, from 0.1% by weight to 5% by weight, from 0.1% by weight to 2.5% by weight, from 0.1% by weight to 2% by weight, or from 0.1% by weight to 1.5% by weight. Higher concentrations, e.g., greater than 20% by weight, are also contemplated depending on the additive.

### Antioxidants

Additives such as such as primary and/or secondary antioxidants may be included in some polyamide compositions as contemplated herein. Primary antioxidants include hindered phenol and amine, and secondary antioxidants include those that are phosphorous-based thioester. Suitable stabilizer additives include, for example, metal phosphites such as sodium, calcium, or aluminum phosphite, or sodium, calcium, or aluminum hypophosphite, etc. Other suitable antioxidants include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. In an exemplary embodiment, the antioxidant is tris-(2,4-di-tert-butyl-phenyl)-phosphite, which is commercially available from several sources such as Irgafos™ 168 (BASF) or Alkanox™ 240 (SI Group). In an exemplary embodiment, the antioxidant is 50% by weight water-based dispersion of the hindered phenolic antioxidant, which is commercially as Lowinox™ HD98 (SI Group). In an exemplary embodiment, the antioxidant is a hindered phenol, which may be commercially available as Irganox 1010, Irganox 1076, and Irganox 1098 (each from BASF).

The concentration of the antioxidant in the polyamide composition can, for example, range from 0% by weight to 10% by weight, e.g., from 0.1% by weight to 7.5% by weight, from 0.1% by weight to 5% by weight, from 0.25% by weight to 5% by weight, from 0.25% by weight to 2.5% by weight, from 0.5% by weight to 2% by weight, from 0.75% by weight to 1.75% by weight, or from 1% by weight to 1.5% by weight. In terms of upper limits, the antioxidant concentration can be less than or equal to 10% by weight, e.g., less than 7.5% by weight, less than 5% by weight, less than 3% by weight, less than 2% by weight, less than 1.8% by weight, less than 1.5% by weight, less than 1.3% by weight, less than 0.75% by weight, or less than 0.5% by weight. In terms of lower limits, the antioxidant concentration can be greater than or equal to 0.05% by weight, e.g. greater than 0.1% by weight, greater than 0.2% by weight, greater than 0.25% by weight, greater than 0.4% by weight, greater than 0.5% by weight, greater than 0.75% by weight, or greater than 1% by weight. Lower concentrations, e.g., less than 0.05% by weight, and higher concentrations, e.g., greater than 10% by weight, are also contemplated.

### Other Polymers

Examples of other polymers that may be present as additives in the polyamide composition may include ethylene-methacrylic acid copolymers, polyetheramides or fluoropolymers, such as polytetrafluoroethylene. In one embodiment, the other polymer may function as an anti-drip agent. In an exemplary embodiment, the other polymer is an ionomer of ethylene-methacrylic acid copolymer, which is commercially available as Surlyn™ 8920 (Dow). In an exemplary embodiment, the other polymer is a polytetrafluoroethylene powder, which is commercially available as MicroFLON™ FR-150 (Shamrock).

The concentration of the other polymers, and in particular ethylene-methacrylic acid copolymers, polyetheramides or fluoropolymers, in the polyamide composition can, for example, range from 0% by weight to 2% by weight, e.g., from 0.05% by weight to 1.9% by weight, from 0.1% by weight to 1.8% by weight, from 0.1% by weight to 1.75% by weight, from 0.2% by weight to 1.5% by weight, from 0.25% by weight to 1.4% by weight, from 0.25% by weight to 1.25% by weight, or from 0.5% by weight to 1.1% by weight. In terms of upper limits, the concentration of the other polymers may be less than or equal to 2% by weight, e.g., less than 1.9% by weight, less than 1.8% by weight, less than 1.7% by weight, less than 1.6% by weight, less than 1.5% by weight, less than 1.4% by weight, less than 1.3% by weight, less than 1.2% by weight, or less than 1.1% by weight. In terms of lower limits, the antioxidant concentration can be greater than or equal to 0.05% by weight, e.g. greater than 0.1% by weight, greater than 0.2% by weight, greater than 0.25% by weight, greater than 0.3% by weight, greater than 0.4% by weight, greater than 0.5% by weight, or greater than 0.75% by weight. Lower concentrations, e.g., less than 0.05% by weight, and higher concentrations, e.g., greater than 2% by weight, are also contemplated.

Light Stabilizers and/or Ultraviolet Light (UV) Absorbing Additives

Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(l,l,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-l,3,5-triazin-2-yl]-5-(octyloxy)-phenol (CYASORB™ 1164); 2,2′-(1,4-phenylene)bis(4H-3,l-benzoxazin-4-one) (CYASORB™ UV-3638); l,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene) bis(4H-3,l-benzoxazin-4-one); l,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers, based on 100 parts by weight of the polymeric components of the polymeric composition. Chain extenders can also be included in the polyamide composition. Suitable chain extender compounds include bis-N-acyl bislactam compounds, isophthaloyl bis-caprolactam (IBC), adipoyl bis-caprolactam (ABC), terephthaloyl bis-caprolactam (TBS), and mixtures thereof.

The polyamide composition can also include anti-block agents. Inorganic solids, usually in the form of diatomaceous earth, represent one class of materials that can be added to the disclosed polyamide composition. Non-limiting examples include calcium carbonate, silicon dioxide, magnesium silicate, sodium silicate, aluminum silicate, aluminum potassium silicate, and silicon dioxide are examples of suitable anti-block agents.

### Nucleating Agent

The disclosed polyamide compositions can also include a nucleating agent to further improve clarity and to enhance oxygen barrier. Typically, these agents are insoluble, high melting point species that provide a surface for crystallite initiation. By incorporating a nucleating agent, more crystals are initiated, which are smaller in nature. More crystallites or higher percentage crystallinity correlate to more reinforcement/higher tensile strength and a more tortuous path for oxygen flux (increased barrier); smaller crystallites decrease light scattering which correlates to improved clarity. Non-limiting examples include calcium fluoride, calcium carbonate, talc and Nylon 2,2.

### Filler

The polyamide composition optionally includes a filler, e.g., a mineral filler that is inorganic. The inorganic mineral filler can include one or more of dolomite, silica, calcium carbonate, magnesium hydroxide, zinc borate, talc, vermiculite, diatomite, perlite, wollastonite, fly ash, kaolin clay, mica, or titanium dioxides, calcium carbonate, magnesium hydroxide, talc, wollastonite, fly ash, or combinations thereof.

The amount of mineral filler in the polyamide composition relative to the amounts of the other components can be selected to advantageously balance melt strength and formability. The concentration of mineral filler in the polyamide composition can, for example, range from 0% by weight to 30% by weight, e.g., from 0% by weight to 10% by weight, from 5% by weight to 15% by weight, from 10% by weight to 20% by weight, from 15% by weight to 25% by weight, or from 20% by weight to 30% by weight. In terms of upper limits, the mineral filler concentration can be less than 30% by weight, e.g., less than 25% by weight, less than 20% by weight, less than 15% by weight, less than 10% by weight, or less than 5% by weight. In terms of lower limits, the mineral filler concentration can be greater than 0% by weight, e.g., greater than 5% by weight, greater than 10% by weight, greater than 15% by weight, greater than 20% by weight, greater than 25% by weight, or greater than 30% by weight. Higher concentrations, e.g., greater than 30% by weight, are also contemplated.

### Impact Modifiers

The polyamide compositions disclosed herein include one or more impact modifiers. In some cases, the impact modifier comprises olefins, acrylates, or acrylics, or combinations thereof, including polymers of these compounds such as polyolefins or polyacrylates. These compounds may be unmodified or modified, e.g., modified (grafted) with maleic anhydride. In some embodiments, the impact modifier comprises a maleic anhydride-modified olefin, neat olefin, acrylate, or acrylic, or their polymeric form, or combinations thereof. In some cases, the impact modifier comprises a modified polyolefin, e.g., a maleic anhydride-modified polyolefin. The impact modifier may comprise a maleic anhydride-modified ethylene octene and/or ethylene acrylate.

In some embodiments, the impact modifier has a glass transition temperature ranging from 0° C. to −100° C., e.g., from −5° C. to −80° C., −10° C. to −70° C., −20° C. to −60° C., or from −25° C. to −55° C. In terms of lower limits, the impact modifier may have a glass transition temperature greater than −100° C., e.g., greater than −80° C., greater than −70° C., greater than −60° C., or greater than −55° C.

In terms of upper limits, the impact modifier may have a glass transition temperature less than 0° C., e.g., less than −5° C., less than −10° C., less than −15° C., or less than −25° C. It is believed that impact modifiers having such glass transition temperatures synergistically improve energy dissipation characteristics, e.g., impact resistance. These particular impact modifiers have glass transition temperatures in temperature ranges that work with the disclosed polyamides and glass fibers to achieve improved impact performance, especially in the desired temperature ranges, e.g., −10° C. to −70° C.

In some embodiments, the impact modifier can include a styrenic copolymer such as an acrylate-butadiene-styrene or a methyl methacrylate-butadiene-styrene. The impact modifier can include an acrylic polymer or a polyethylene polymer such as a chlorinated polyethylene. In some embodiments, the impact modifier includes an ethylene-octene copolymer. In some cases, the combination of the impact modifier and the melt stabilizers (optionally in the disclosed amounts and ratios) provides for surprising, synergistic combinations of performance features, e.g., tensile/flexural performance and impact resistance.

The concentration of the impact modifier in the polyamide composition can, for example, range from 3% by weight to 30% by weight, e.g., from 3% by weight to 19.2% by weight, from 3% by weight to 25% by weight, from 3% by weight to 20% by weight, from 5.7% by weight to 21.9% by weight, from 4.0% by weight to 15% by weight, from 5.5% by weight to 14% by weight, from 6.0% by weight to 11.5% by weight, from 8.4% by weight to 24.6% by weight, from 11.1% by weight to 27.3% by weight, or from 13.8% by weight to 30% by weight. In some embodiments, the concentration of the impact modifier ranges from 6% by weight to 20% by weight, e.g., from 6% by weight to 14.4% by weight, from 7.4% by weight to 15.8% by weight, from 8.8% by weight to 17.2% by weight, from 10.2% by weight to 18.6% by weight, or from 11.6% by weight to 20% by weight. In terms of upper limits, the impact modifier concentration can be less than 30% by weight, e.g., less than 27.3% by weight, less than 25.0% by weight, less than 24.6% by weight, less than 21.9% by weight, less than 20% by weight, less than 18.6% by weight, less than 17.2% by weight, less than 15.8% by weight, less than 15% by weight, less than 14% by weight, less than 14.4% by weight, less than 13% by weight, less than 11.6% by weight, less than 11.5% by weight, less than 10.2% by weight, less than 8.8% by weight, less than 7.4% by weight, less than 6% by weight, or less than 5.4% by weight. In terms of lower limits, the impact modifier concentration can be greater than 3% by weight, greater than 4.0% by weight, greater than 5.5% by weight, greater than 5.4% by weight, greater than 6% by weight, greater than 7.4% by weight, greater than 8.8% by weight, greater than 10.2% by weight, greater than 11.6% by weight, greater than 13% by weight, greater than 14.4% by weight, greater than 15.8% by weight, greater than 17.2% by weight, greater than 18.6% by weight, greater than 20% by weight, greater than 21.9% by weight, greater than 24.6% by weight, greater than 25.0% by weight, or greater than 27.6% by weight. Lower concentrations, e.g., less than 3% by weight, and higher concentrations, e.g., greater than 30% by weight, are also contemplated.

In aspects, the concentration of impact modifier in the polyamide composition is present in an amount greater than 3% by weight. In some cases, the combination of the impact modifier and the melt stabilizers (optionally in the disclosed amounts and ratios) provides for surprising, synergistic combinations of performance features, e.g., tensile/flexural performance and impact resistance.

The additive of impact modifier is important to the polyamide compositions described herein because the impact modifier, e.g., olefins, acrylates, or acrylics, or combinations thereof, contributes to the mechanical performance, including elongation and impact strength, and reduced modulus of the resultant articles such as an extruded article, a profile extrusion article, a monofilament, or a fiber that are desired for automotive and other applications.

### Colorants

The polyamide composition can include one or more colorants, e.g., soluble dyes such as nigrosine (0.5%, 30% active) or solvent black 7. The concentration of the nigrosine in the polyamide composition can, for example, range from 0.1 to 5% by weight, e.g., from 0.1% by weight to 1% by weight, from 0.15% by weight to 1.5% by weight, from 0.22% by weight to 2.3% by weight, from 0.32% by weight to 3.4% by weight, or from 0.48% by weight to 5.0% by weight. In some embodiments, the concentration of the nigrosine ranges from 1.0% by weight to 2.0% by weight, e.g., from 1.0% by weight to 1.6% by weight, from 1.1% by weight to 1.7% by weight, from 1.2% by weight to 1.8% by weight, from 1.3% by weight to 1.9% by weight, or from 1.4% by weight to 2.0% by weight. In terms of upper limits, the nigrosine concentration can be less than 5.0% by weight, e.g., less than 3.4% by weight, less than 2.3% by weight, less than 2.0% by weight, less than 1.9% by weight, less than 1.8% by weight, less than 1.7% by weight, less than 1.6% by weight, less than 1.5% by weight, less than 1.4% by weight, less than 1.3% by weight, less than 1.2% by weight, less than 1.1% by weight, less than 1.0% by weight, less than 0.71% by weight, less than 0.48% by weight, less than 0.32% by weight, less than 0.22% by weight, or less than 0.15% by weight. In terms of lower limits, the nigrosine concentration can be greater than 0.1% by weight, e.g., greater than 0.15% by weight, greater than 0.22% by weight, greater than 0.32% by weight, greater than 0.48% by weight, greater than 0.71% by weight, greater than 1.0% by weight, greater than 1.1% by weight, greater than 1.2% by weight, greater than 1.3% by weight, greater than 1.4% by weight, greater than 1.5% by weight, greater than 1.6% by weight, greater than 1.7% by weight, greater than 1.8% by weight, greater than 1.9% by weight, greater than 2.0% by weight, greater than 2.3% by weight, or greater than 3.4% by weight. Lower concentrations, e.g., less than 0.1% by weight, and higher concentrations, e.g., greater than 5.0% by weight, are also contemplated. In some cases, the nigrosine is provided in a masterbatch, and the concentration of the nigrosine or dye in the masterbatch and in the resultant composition can be easily calculated.

The polyamide composition can include one or more particulates such as carbon black (0.5%, 35% active). The concentration of the carbon black in the polyamide composition can, for example, range from 0.1 to 5.0% by weight, e.g., from 0.1% by weight to 1.0% by weight, from 0.15% by weight to 1.5% by weight, from 0.22% by weight to 2.3% by weight, from 0.32% by weight to 3.4% by weight, or from 0.48% by weight to 5.0% by weight. In some embodiments, the concentration of the carbon black ranges from 1.0% by weight to 2.0% by weight, e.g., from 1.0% by weight to 1.6% by weight, from 1.1% by weight to 1.7% by weight, from 1.2% by weight to 1.8% by weight, from 1.3% by weight to 1.9% by weight, or from 1.4% by weight to 2.0% by weight. In terms of upper limits, the carbon black concentration can be less than 5.0% by weight, e.g., less than 3.4% by weight, less than 2.3% by weight, less than 2.0% by weight, less than 1.9% by weight, less than 1.8% by weight, less than 1.7% by weight, less than 1.6% by weight, less than 1.5% by weight, less than 1.4% by weight, less than 1.3% by weight, less than 1.2% by weight, less than 1.1% by weight, less than 1.0% by weight, less than 0.71% by weight, less than 0.48% by weight, less than 0.32% by weight, less than 0.22% by weight, or less than 0.15% by weight. In terms of lower limits, the carbon black concentration can be greater than 0.1% by weight, e.g., greater than 0.15% by weight, greater than 0.22% by weight, greater than 0.32% by weight, greater than 0.48% by weight, greater than 0.71% by weight, greater than 1.0% by weight, greater than 1.1% by weight, greater than 1.2% by weight, greater than 1.3% by weight, greater than 1.4% by weight, greater than 1.5% by weight, greater than 1.6% by weight, greater than 1.7% by weight, greater than 1.8% by weight, greater than 1.9% by weight, greater than 2.0% by weight, greater than 2.3% by weight, or greater than 3.4% by weight. Lower concentrations, e.g., less than 0.1% by weight, and higher concentrations, e.g., greater than 5.0% by weight, are also contemplated. In some cases, the carbon black is provided in a masterbatch, and the concentration of the carbon black in the masterbatch and in the resultant composition can be easily calculated.

The weight ratio of one or more polyamide polymers to the nigrosine and/or carbon black in the polyamide composition can, for example, range from 1 to 85, e.g., from 1 to 14, from 1.6 to 22, from 2.4 to 35, from 3.8 to 55, or from 5.9 to 85. In terms of upper limits, the ratio of the one or more polyamide polymers to the nigrosine can be less than 85, e.g., less than 55, less than 35, less than 22, less than 14, less than 9.2, less than 5.9, less than 3.8, less than 2.4, or less than 1.6. In terms of lower limits, the ratio of the one or more polyamide polymers to the nigrosine can be greater than 1, e.g., greater than 1.6, greater than 2.4, greater than 3.8, greater than 5.9, greater than 9.2, greater than 14, greater than 22, greater than 35, or greater than 55. Higher ratios, e.g., greater than 55, and lower ratios, e.g., less than 1, are also contemplated.

The polyamide composition can include one or more pigments such as carbon black. The concentration of the carbon black in the polyamide composition can, for example, range from 0.1 to 5.0% by weight, e.g., from 0.1% by weight to 1.05% by weight, from 0.15% by weight to 1.55% by weight, from 0.22% by weight to 2.29% by weight, from 0.32% by weight to 3.38% by weight, or from 0.48% by weight to 5.0% by weight. In some embodiments, the concentration of the carbon black ranges from 0.2% by weight to 0.8% by weight. In terms of upper limits, the carbon black concentration can be less than 5.0% by weight, e.g., less than 3.4% by weight, less than 2.3% by weight. less than 1.5% by weight, less than 1.0% by weight, less than 0.71% by weight, less than 0.48% by weight, less than 0.32% by weight, less than 0.22% by weight, or less than 0.15% by weight. In some embodiments, the concentration of the carbon black is less than 3.0% by weight. In terms of lower limits, the carbon black concentration can be greater than 0.1% by weight, e.g., greater than 0.15% by weight, greater than 0.22% by weight, greater than 0.32% by weight, greater than 0.48% by weight, greater than 0.71% by weight, greater than 1.0% by weight, greater than 1.5% by weight, greater than 2.3% by weight, or greater than 3.4% by weight. Lower concentrations, e.g., less than 0.1% by weight, and higher concentrations, e.g., greater than 5.0% by weight, are also contemplated.

In aspects, the concentration of colorant in the polyamide composition is present in an amount greater than 0.1% by weight. The additive of colorant is important to the polyamide compositions described herein because the colorant, e.g., nigrosine and/or carbon black, contributes to the performance of the resultant articles such as an extruded article, a profile extrusion article, a monofilament, or a fiber.

### Mechanical Performance Properties

In the electrical/electronic industry, there is a trend towards miniaturization and integration of electronic components that demands higher performing thermoplastic resins. The polyamides described herein are able to meet these expanded demands by providing excellent flammability testing, increased Glow Wire Ignition Temperature (GWIT) temperatures, improved flame retardancies, superior heat resistance and improved elongation at break/toughness. The unique combination of elevated GWIT temperatures and elongation at break allow the polyamide compositions to be used in several different applications.

In one embodiment, the polyamide composition having a aliphatic polyamide comprising a dimer monomer and non-halogen flame retardant composition has good elongation property. The elongation at break of the polyamide composition can be measured using a standard protocol such as ISO 527-1 (2019).

The polyamide composition can demonstrate an elongation (tensile) at break that is greater than 100%. In one embodiment, the elongation at break of the polyamide composition may be from 100% to 700%, e.g., from 100% to 650%, from 100% to 600%, from 105% to 550%, from 110% to 500%, from 110% to 450%, from 110% to 400%, from 110% to 350%, or from 115% to 300%. In terms of lower limits, the elongation at break should be at a minimum greater than or equal to 100%, e.g., greater than 105%, greater than 110%, greater than 115%, greater than 120%, greater than 125%, greater than 150%, or greater than 200%. In terms of upper limits, the elongation at break is not particularly limited but generally is less than or equal to 700%, e.g., less than 650%, less than 600%, less than 550% or less than 500%.

Flammability testing was conducted on samples at various thicknesses (0.4 mm, 0.75 mm, 1.5 mm, and 3.0 mm) according to the UL94 standard. In one embodiment, the polyamide composition has a UL94 classification of V-0. In one embodiment, the polyamide composition has a UL94 classification of V-1. In one embodiment, the polyamide composition has a UL94 classification of V-2.

Glow Wire Ignition Temperature (GWIT) at thicknesses (0.75 mm) is tested according to IEC 60695-2-13.

The polyamide composition can demonstrate a tensile modulus measured using a standard protocol such as ISO 527-1 (2019) that, for example, ranges from 650 MPa to 3000 MPa, e.g., from 650 MPa to 2700 MPa, from 700 MPa to 2650 MPa, from 750 MPa to 2600 MPa, from 800 MPa to 2600 MPa, from 850 MPa to 2500 MPa, from 900 MPa to 2500 MPa, from 950 MPa to 2500 MPa, or from 1000 MPa to 2500 MPa. In terms of upper limits, the tensile modulus can be less than or equal to 3000 MPa, e.g., less than 2900 MPa, less than 2800 MPa, less than 2700 MPa, less than 2600 MPa, less than 2500 MPa, less than 2400 MPa, or less than 2300 MPa. In terms of lower limits, the tensile modulus can be greater than or equal to 650 MPa, e.g., greater than 700 MPa, greater than 750 MPa, greater than 800 MPa, greater than 850 MPa, greater than 900 MPa, greater than 950 MPa, greater than 1000 MPa, or greater than 1100 MPa. Higher tensile moduli, e.g., greater than 3000 MPa, and lower tensile moduli, e.g., less than 650 MPa, are also contemplated.

The polyamide composition can demonstrate a tensile strength at break that, for example, ranges from 25 MPa to 150 MPa, e.g., from 25 MPa to 125 MPa, from 30 MPa to 125 MPa, from 30 MPa to 120 MPa, from 30 MPa to 115 MPa, from 35 MPa to 110 MPa, from 35 MPa to 100 MPa, or from 40 MPa to 75 MPa. In terms of upper limits, the tensile strength at break can be less than or equal to 150 MPa, e.g., less than 125 MPa, less than 120 MPa, less than 115 MPa, less than 110 MPa, less than 105 MPa, less than 100 MPa, or less than 95 MPa. In terms of lower limits, the tensile strength at break can be greater than or equal to 25 MPa, e.g., greater than 30 MPa, greater than 35 MPa, greater than 40 MPa, greater than 45 MPa, or greater than 50 MPa. Higher tensile strengths, e.g., greater than 75 MPa, and lower tensile strengths, e.g., less than 35 MPa, are also contemplated. The tensile strength at break of the polyamide composition can be measured using a standard protocol such as ISO 527-1 (2019).

The polyamide composition can demonstrate a Charpy notched impact energy loss at 23° C. that, for example, ranges from 3 kJ/m² to 17 kJ/m², e.g., from 3 kJ/m² to 5 kJ/m², from 3.5 kJ/m² to 5.5 kJ/m², from 4 kJ/m² to 6 kJ/m², from 4.5 kJ/m² to 6.5 kJ/m², from 5 kJ/m² to 7 kJ/m², from 6 kJ/m² to 8 kJ/m², from 7 kJ/m² to 9 kJ/m², from 8 kJ/m² to 10 kJ/m², from 9 kJ/m² to 11 kJ/m², from 10 kJ/m² to 12 kJ/m², from 11 kJ/m² to 13 kJ/m², from 12 kJ/m² to 14 kJ/m², from 13 kJ/m² to 15 kJ/m², from 14 kJ/m² to 16 kJ/m², or from 15 kJ/m² to 17 kJ/m². In terms of upper limits, the Charpy notched impact energy loss at 23° C. can be less than 17 kJ/m², e.g., less than 16 kJ/m², less than 15 kJ/m², less than 14 kJ/m², less than 13 kJ/m², less than 12 kJ/m², less than 11 kJ/m², less than 10 kJ/m², less than 9 kJ/m², less than 8 kJ/m², less than 7 kJ/m², less than 6 kJ/m², less than 5 kJ/m², less than 4.5 kJ/m², less than 4 kJ/m², or less than 3.5 kJ/m². In terms of lower limits, the Charpy notched impact energy loss at 23° C. can be greater than 3 kJ/m², e.g., greater than 4 kJ/m², greater than 5 kJ/m², greater than 6 kJ/m², greater than 7 kJ/m², greater than 8 kJ/m², greater than 9 kJ/m², greater than 10 kJ/m², greater than 11 kJ/m², greater than 12 kJ/m², greater than 13 kJ/m², greater than 14 kJ/m², greater than 15 kJ/m², or greater than 16 kJ/m². Higher Charpy notched impact energy losses, e.g., greater than 17 kJ/m², and lower Charpy notched impact energy losses, e.g., less than 3 kJ/m², are also contemplated. The Charpy notched impact energy loss of the polyamide composition can be measured using a standard protocol such as ISO 179-1 (2010).

The polyamide composition can demonstrate a Charpy unnotched impact energy loss at 23° C. that, for example, ranges from 25 kJ/m² to 250 kJ/m², e.g., from 30 kJ/m² to 225 kJ/m², from 35 kJ/m² to 205 kJ/m², from 35 kJ/m² to 200 kJ/m², from 35 kJ/m² to 195 kJ/m², from 40 kJ/m² to 195 kJ/m², from 45 kJ/m² to 195 kJ/m², from 50 kJ/m² to 190 kJ/m², or from 60 kJ/m² to 190 kJ/m². In terms of upper limits, the Charpy unnotched impact energy loss at 23° C. can be less than or equal to 250 kJ/m², e.g., less than 240 kJ/m², less than 230 kJ/m², less than 225 kJ/m², less than 220 kJ/m², less than 210 kJ/m², less than 200 kJ/m², less than 195 kJ/m², less than 190 kJ/m², less than 185 kJ/m², or less than 185 kJ/m². In terms of lower limits, the Charpy unnotched impact energy loss at 23° C. can be greater than or equal to 25 kJ/m², e.g., greater than 30 kJ/m², greater than 35 kJ/m², greater than 40 kJ/m², greater than 45 kJ/m², greater than 50 kJ/m², greater than 55 kJ/m², greater than 60 kJ/m², greater than 65 kJ/m², greater than 70 kJ/m², or greater than 75 kJ/m². Higher Charpy unnotched impact energy losses, e.g., greater than 250 kJ/m², and lower Charpy unnotched impact energy losses, e.g., less than 25 kJ/m², are also contemplated. The Charpy unnotched impact energy loss of the polyamide composition can be measured using a standard protocol such as ISO 179-1 (2010).

The polyamide composition can demonstrate a notched IZOD impact strength at 23° C. that, for example, ranges from 25 kJ/m² to 250 kJ/m², e.g., from 30 kJ/m² to 225 kJ/m², from 35 kJ/m² to 205 kJ/m², from 35 kJ/m² to 200 kJ/m², from 35 kJ/m² to 195 kJ/m², from 40 kJ/m² to 195 kJ/m², from 45 kJ/m² to 195 kJ/m², from 50 kJ/m² to 190 kJ/m², or from 60 kJ/m² to 190 kJ/m². In terms of upper limits, the notched IZOD impact strength at 23° C. can be less than or equal to 250 kJ/m², e.g., less than 240 kJ/m², less than 230 kJ/m², less than 225 kJ/m², less than 220 kJ/m², less than 210 kJ/m², less than 200 kJ/m², less than 195 kJ/m², less than 190 kJ/m², less than 185 kJ/m², or less than 185 kJ/m². In terms of lower limits, notched IZOD impact strength at 23° C. can be greater than or equal to 25 kJ/m², e.g., greater than 30 kJ/m², greater than 35 kJ/m², greater than 40 kJ/m², greater than 45 kJ/m², greater than 50 kJ/m², greater than 55 kJ/m², greater than 60 kJ/m², greater than 65 kJ/m², greater than 70 kJ/m², or greater than 75 kJ/m². Higher notched IZOD impact strength, e.g., greater than 250 kJ/m², and lower notched IZOD impact strength, e.g., less than 25 kJ/m², are also contemplated. The notched IZOD impact strength of the polyamide composition can be measured using a standard protocol such as ISO 180.

The polyamide composition can demonstrate a flexural strength at 23° C. that, for example, ranges from 25 MPa to 150 MPa, e.g., from 25 MPa to 125 MPa, from 30 MPa to 125 MPa, from 30 MPa to 120 MPa, from 30 MPa to 115 MPa, from 35 MPa to 110 MPa, from 35 MPa to 100 MPa, or from 40 MPa to 75 MPa. In terms of upper limits, the tensile strength at break can be less than or equal to 150 MPa, e.g., less than 125 MPa, less than 120 MPa, less than 115 MPa, less than 110 MPa, less than 105 MPa, less than 100 MPa, or less than 95 MPa. In terms of lower limits, the tensile strength at break can be greater than or equal to 25 MPa, e.g., greater than 30 MPa, greater than 35 MPa, greater than 40 MPa, greater than 45 MPa, or greater than 50 MPa. Higher tensile strengths, e.g., greater than 75 MPa, and lower tensile strengths, e.g., less than 35 MPa, are also contemplated. The tensile strength at break of the polyamide composition can be measured using a standard protocol such as ISO 178.

The polyamide composition can demonstrate a chemical resistance that, for example, resists various acids, bases, solvents, etc. by assessing swelling, dissolution, weight loss, and other properties. The polyamide composition can demonstrate an abrasion resistance that is, for example, greater than or equal to that of PA6/12 and/or PA12.

### Methods of Preparation

The present disclosure also relates to processes of producing the provided polyamide compositions. The methods include providing one or more polyamide polymers, a dimer monomer comprising a dimer acid or a dimer amine or a combination thereof, the non-halogen flame retardant and optionally other additives. The methods can further include selecting the type and relative amounts of the one or more polyamide polymers and the monomer comprising a dimer acid or a dimer amine or a combination thereof to provide desired chemical resistance, reduced water uptake, and mechanical properties to the resulting polyamide composition. The methods further include combining one or more polyamide polymers and the monomer comprising a dimer acid or a dimer amine or a combination thereof to produce the polyamide composition. In some embodiments, the methods further include selecting, providing, and/or combining one or more dyes such as nigrosine, one or more pigments such as carbon black, one or more mineral filters, and/or one or more melt stabilizers/lubricants.

The components of the polyamide composition can be mixed and blended together to produce the polyamide composition, or can be formed in situ using appropriate reactants. The terms “adding” or “combining” without further clarification are intended to encompass either the addition of the material itself to the composition or the in situ formation of the material in the composition. In some embodiments, the polyamide composition is prepared using a high solids approach from individual components rather than from individual aqueous based salts. The solids content of the first solution containing the polymer components is greater than 80%. The solution may then be evaporated in an evaporator. The dimer monomer can bypass the evaporator and then be added to form a single mixture. The monomer comprises a dimer acid or a dimer amine or combinations thereof, wherein the monomer includes from 18 to 44 carbon atoms. The high solids method is advantageous when employing hydrogenated dimer materials, e.g., hydrogenated dimer acid or hydrogenated dimer amine, which are highly hydrophobic.

In other embodiments, suitable for pilot, scale-up, or commercial operations, water soluble nylon salts (e.g., PA6,6, PA6,10, PA6,12, and others) are processed through an evaporation step to increase the solids content from a starting range of 40% by weight to 50% by weight up to a range of 75% by weight to 90% by weight. After evaporation, the salt is then pumped into a reaction vessel and combined with the hydrogenated dimer monomer, e.g. hydrogenated dimer acid or hydrogenated dimer amine. The temperature in the vessel is then elevated to a temperature ranging from 220° C. to 270° C. under pressures ranging from 185 psia to 270 psia. The pressure is then reduced to atmospheric over a period of 30 minutes to 90 minutes while the temperature is maintained between 250° C. and 270° C. After the pressure reaches atmospheric, finishing is then performed either at atmospheric pressure or under vacuum. Pressures range from 2 psia to 10 psia when vacuum is applied. Finishing times can range between 10 minutes and 60 minutes depending on the desired viscosity/molecular weight. After finishing, nitrogen head pressure is applied and the molten polymer is extruded through a circular die, submersed underwater in a strand tray, and sent to a strand pelletizer. After pelletizing, surface moisture is removed from the pellets using residual heat and air from a spin dryer; pellets are collected in a foil-lined container.

In another embodiment, two or more materials to be combined with the composition are simultaneously added via masterbatch.

### Molded Articles

The present disclosure also relates to articles that include any of the provided polyamide compositions. In one embodiment, a three-dimensional article comprising one of the polyamide composition described herein is produced. The article can be produced, for example, via injection molding, extrusion molding, blow molding, press molding, compression molding, or gas assist molding techniques. The three-dimensional article comprises moldings, injection-molded parts, extrusion compounds and/or extruded parts. Examples of articles that can be made with the provided polyamide compositions include those used in electrical and electronic applications (such as, but not limited to, antenna frames, bus bars, cables, capacitor housings, cell phone frames, circuit boards, circuit breakers, coil elements, connector sockets, connectors, terminal blocks, encapsulating compounds, flexible printed circuit boards, lamp housings, laptop frames, LED housings, plug connectors, power plugs, sensor housings and the like), automotive applications (such as, but not limited to, air handling systems, engine covers, radiator end tanks, fans, shrouds, and the like), furniture and appliance parts, and wire positioning devices such as cable ties.

In some embodiments, an injection molded article comprising any of the provided polyamide compositions is provided. In other embodiments, an extruded article of any of the provided polyamide compositions is provided and can be a profile extrusion article, a monofilament, or a fiber.

### Examples

Examples 1-14 were prepared using the formulations listed in Table 1. Four different polyamide resins were used. Polyamide Resin A (D3X) is a polyamide 6/12 having an initial elongation of 210% and a viscosity number of 173. Polyamide Resin B (D1X) is a polyamide 6/12 having an initial elongation of 81% and a viscosity number of 123. Polyamide Resin C (D2X) is a polyamide 6/12 having an initial elongation of 170%. Polyamide Resins A, B and C do not have any dimer monomer. As shown in Table 1, the various polyamide resins were combined with non-halogenated flame retardants (hexaphenoxylcyclotriphosphazene (HPCTP), dimethyl pentaerythritol diphosphonate and is commercially available as Aflammit™ PCO 900 from Thor, melamine cyanurate, polyphosphonates commercially available as NOFIO™ HM5000, NOFIO™ HM7000, or NOFIO™ HM9000 from FRX Products, or monomeric N-alkoxy hindered amine commercially available as Flamestab NOR 116 from BASF) and a polyalcohol (Aldrich dipentaerythritol (DPE)), plasticizers (Celanese PLX Plasticizer or diundecyl phthalate), and antioxidants (Lowinox HD98 or Irganox™ 168). Other additives such as anti-dripping agents (PTFE or Surlyn™ 8920), lubricants (Zinc stearate or Acrawax™ C Prilled) and polyamide 6,6, were selectively added as indicated in Table 1.

The following properties of the polyamide composition were determined and the results are shown in Table 2.

TABLE 1

| Example | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| PA Resin | A | A | A | A | B | C | C | A | A | A | A | A | A | A |
| PA Resin Amount % | 88.8 | 84.9 | 72 | 72 | 70 | 77.4 | 77.4 | 90.8 | 76.9 | 84.4 | 80.4 | 87.9 | 87.9 | 82 |
| Non-halogenated flame retardants | | | | | | | | | | | | | | |
| HPCTP | | 10 | 10 | 10 | 10 | 10 | 10 | | 20 | 10 | 10 | | | |
| Thor PCO 900 | | | 8 | 8 | 8 | | | | | | | 7 | 11 | 8 |
| Melamine | 7 | 2 | | | | 7 | | 7 | | 2 | 4 | | | |
| Cyanurate | | | | | | | | | | | | | | |
| NOFIA HM9000 | | | | | | | 7 | | | | | | | |
| NOR 116 | | | 2 | 2 | 2 | | | | | | | 2 | | 2 |
| Polyalcohol | | | | | | | | | | | | | | |
| Aldrich DPE | | | | | 2 | 2 | 2 | | | | | | | |
| Plasticizer | | | | | | | | | | | | | | |
| Celanese PLX | | | 4 | 4 | 4 | 4 | 4 | | | | | | | 4 |
| Diundecyl phthalate | 2 | 2 | | | | | | | 2 | 2 | 2 | 2 | 3 | |
| Antioxidants | | | | | | | | | | | | | | |
| Lowinox HD98 | 1 | 1 | 0.75 | 0.75 | 0.75 | 1 | 1 | 1 | 1 | 1 | 1 | 1 | 0.75 | 0.75 |
| Irg. 168 | | | 0.75 | 0.75 | 0.75 | | | | | | | | 0.75 | 0.75 |
| PTFE | | | 0.5 | 0.5 | 0.5 | 0.5 | 0.5 | | | 0.5 | 0.5 | | | 0.5 |
| Surlyn 8920 | | | | | | | | | | | 2 | | | |
| Zinc stearate | 0.1 | 0.1 | 2 | 2 | 2 | | | 0.1 | 0.1 | 0.1 | 0.1 | 0.1 | 2 | 2 |
| Acrawax C, Prill | | | | | | 0.1 | 0.1 | | | | | | | |
| PA6,6 Resin | 1.1 | — | — | — | — | — | — | 1.1 | — | — | — | — | — | — |

TABLE 2

| Examples | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Elongation at break, | 64 | 52 | 72 | 70 | 31 | | | 27 | 109 | 94 | 124 | 30 | 24 | 35 |
| % | | | | | | | | | | | | | | |
| UL-94 | | | | | | | | | | | | | | |
| 0.4 mm | V-2: 16 | V-2: 9 | V-2: 3 | V-2: 2 | V-0 | | | V-2: 16 | Burn | V-2 | Burn | V-0 | Burn | V-2: 3 |
| 0.75 mm | V-2: 12 | V-2: 13 | V-2: 2 | V-2: 2 | V-0 | | | V-2: 12 | Burn | Burn | V-2 | V-0 | V-2 | V-2: 2 |
| 1.5 mm | V-2: 12 | V-2: 13 | V-2: 13 | V-2: 7 | V-2 | | | V-2: 12 | V-2 | Burn | V-2 | V-0 | V-2 | V-2: 13 |
| 3 mm | V-2: 12 | V-2: 7 | V-2: 1 | V-2: 56 | V-2: (l9) | | | V-2: 12 | V-2 | V-2 | Burn | V-2 | V-2 | V-2: 1 |
| GWIT @0.75 mm, ° C. | — | — | — | — | — | | | — | — | — | — | — | — | — |
| Viscosity Number | — | 176 | 195 | 124 | 131 | | | — | — | 173 | 167 | 289 | 192 | 195 |
| Tensile Strength | 98 | 54 | 46 | 37 | 36 | | | 65 | 52 | 51 | 47 | 66 | — | 51 |
| (MPa) | | | | | | | | | | | | | | |
| Tensile Modulus | 2,500 | 1,900 | 1,500 | 1,200 | 1,200 | | | 2600 | 1,900 | 1,900 | 1,800 | 2,300 | — | 1,700 |
| (MPa) | | | | | | | | | | | | | | |
| Flex Strength | 76 | 61 | 42 | 32 | 34 | | | 76 | 57 | 52 | 50 | 66 | — | 47 |
| (MPa) | | | | | | | | | | | | | | |
| Notched Charpy | 5 | 8 | 11 | 8 | 4 | | | 9 | 6 | 8 | 6 | 6.5 | — | 5.5 |
| (kJ/m²) | | | | | | | | | | | | | | |
| Unnotched Charpy | 193 | 193 | — | 183 | 57 | | | 134 | 190 | 190 | 190 | — | — | — |
| (kJ/m²) | | | | | | | | | | | | | | |
| Notched IZOD | 5.1 | 6.1 | 6.2 | 7 | 4.4 | | | 4.9 | 5.2 | 6 | 5.6 | — | — | 4.8 |
| (kJ/m²) | | | | | | | | | | | | | | |
| Heat Deflection | 57 | 52 | 49 | 45 | 45 | | | 60 | 51 | 53 | 50 | 53 | — | 55 |
| Temperature, ° C. | | | | | | | | | | | | | | |
| YI | 6 | — | 55 | 62 | 61 | | | 6 | 12 | 9 | 8 | 69 | 12 | 55 |

Examples 15-25 were prepared using the formulations listed in Table 3 using polyamide resin D is a polyamide composition of polyamide 12/6 and a dimer acid having a 36 carbon atoms. As shown in Table 3, the various polyamide resins were combined with non-halogenated flame retardants (hexaphenoxylcyclotriphosphazene (HPCTP), phenoxy phosphazene (C12H10NPO2)n, n=3-6 commercially available as Rabitle™ FP-110 from Fushimi dimethyl pentaerythritol diphosphonate and is commercially available as Aflammit™ PCO 900 from Thor, melamine cyanurate, polyphosphonates commercially available as NOFIO™ HM5000, NOFIO™ HM7000, or NOFIO™ HM9000 from FRX Products, monomeric N-alkoxy hindered amine commercially available as Flamestab NOR 116 from BASF, hindered amine NOR stabilizer commercially available as Tinuvin™ NOR 371, ortetraphenyl m-phenylene bis(phosphate) commercially available as Fyrolflex™ Sol-DP or Fyrolflex™ RDP from ICL Industrial Products). The polyalcohol used with the formulations in Table 3 included Aldrich dipentaerythritol (DPE) or Charflam™ 300-DP DPE. The plasticizers included Celanese PLX Plasticizer or diundecyl phthalate, and antioxidants included Lowinox HD98 or Irganox™ 168. Other additives such as anti-dripping agents (PTFE or Surlyn™ 8920), lubricants (Zinc stearate or Acrawax™ C Prilled) and polyamide 6,6, were selectively added as indicated in Table 3.

TABLE 3

| Example | 15 | 16 | 17 | 18 | 19 | 20 | 21 | 22 | 23 | 24 | 25 |
|---|---|---|---|---|---|---|---|---|---|---|---|
| PA Resin | D | D | D | D | D | D | D | D | D | D | D |
| PA Resin Amount % | 72.0 | 78.4 | 78.4 | 78.4 | 78.4 | 76.4 | 74.0 | 74.0 | 74.0 | 74.0 | 74.0 |
| Non-Halogenated Flame Retardant | | | | | | | | | | | |
| HPCTP | 10 | | | | | | | | | | |
| FP-110 | | | | | 5 | 5 | 10 | 5 | 5 | 5 | 5 |
| Thor PCO 900 | 8 | | | | | | 8 | 8 | 8 | 8 | 8 |
| Melamine | | 5 | 5 | 5 | 5 | 5 | | | | | |
| Cyanurate | | | | | | | | | | | |
| NOFIA HM9000 | | | 5 | | | | | | | | |
| NOFIA HM7000 | | | | 5 | 5 | 5 | | | | | |
| NOFIA HM5000 | | 5 | | | | | | | | | |
| NOR 116 | 2 | | | | | | 2 | 2 | | 2 | 2 |
| TinuvinNOR 371 | | | | | | | | | 2 | | |
| Sol-DP | | 5 | 5 | 5 | | | | | | | |
| RDP | | | | | 5 | | | | | | |
| Polyalcohol | | | | | | | | | | | |
| Aldrich DPE | 2 | | | | | | 2 | 2 | 2 | | |
| Charflam 300-DP | | 5 | 5 | 5 | 5 | 5 | | | | 2 | 2 |
| Plasticizer | | | | | | | | | | | |
| Celanese PLX | 4 | | | | | | | | | | |
| Diundecyl | | | | | | 2 | | | | | |
| phthalate | | | | | | | | | | | |
| Antioxidants | | | | | | | | | | | |
| Lowinox HD98 | 0.75 | 0.75 | 0.75 | 0.75 | 0.75 | 0.75 | 0.75 | 0.75 | 0.75 | 0.75 | 0.75 |
| Irg. 168 | 0.75 | 0.75 | 0.75 | 0.75 | 0.75 | 0.75 | 0.75 | 0.75 | 0.75 | 0.75 | 0.75 |
| PTFE | 0.5 | | | | | | 0.5 | 0.5 | 0.5 | 0.5 | 0.5 |
| Surlyn 8920 | | | | | | | | | | | |
| Zinc stearate | 2 | | | | | | 2 | 2 | 2 | 2 | 2 |
| Acrawax C, Prill | | 0.1 | 0.1 | 0.1 | 0.1 | 0.1 | | | | | |
| PA6,6 Resin | | | | | | | | | | | |

The following properties of the polyamide composition were determined and the results are shown in Table 4.

TABLE 4

| Example | 15 | 16 | 17 | 18 | 19 | 20 | 21 | 22 | 23 | 24 | 25 |
|---|---|---|---|---|---|---|---|---|---|---|---|
| Elongation at break, | 239 | 178 | 185 | 180 | 168 | 179 | 162 | 253 | 245 | 222 | 237 |
| % | | | | | | | | | | | |
| UL-94 | | | | | | | | | | | |
| 0.4 mm | V-0 | V-2: 0 | V-2: 0 | V-2: 0 | V-2: 1 | V-2: 0 | V-0; 1 | V-0; 0 | V-2; 0 | V-0; 1 | V-0; 5 |
| 0.75 mm | V-0 | V-2: 0 | V-2: 0 | V-2: 0 | V-2: 1 | V-2: 1 | V-0; 0 | V-0; 0 | V-0; 0 | V-0; 0 | V-0; 2 |
| 1.5 mm | V-0 | V-2: 4 | V-2: 4 | V-2: 4 | V-2: 3 | V-2: 2 | V-0; 0 | V-0; 0 | V-0; 2 | V-0; 6 | V-0; 2 |
| 3 mm | V-0 | V-0: 4 | V-0: 0 | V-0: 0 | V-0: 5 | V-0: 0 | V-0; 0 | V-0; 0 | V-0; 3 | V-0; 0 | V-0; 1 |
| GWIT @0.75 mm, ° C. | 960 | 960 | 960 | 960 | 960 | 960 | | | 930 | 930 | 930 |
| MVR @230° C., 2.16 kg | 8 | | | | | | | 16 | 11 | 14 | 13 |
| MVR @230° C., 5 kg | 28 | | | | | | | 46 | 39 | 43 | 42 |
| Viscosity Number | | | | | | | | | | | |
| Tensile Strength | 33 | 34 | 35 | 35 | 36 | 34 | 31 | 35 | 35 | 34 | 35 |
| (MPa) | | | | | | | | | | | |
| Tensile Modulus | 340 | 930 | 890 | 1,000 | 1,100 | 1,000 | 540 | 630 | 600 | 620 | 610 |
| (MPa) | | | | | | | | | | | |
| Flex Strength | 9 | 22 | 22 | 24 | 27 | 24 | 13 | 13 | 13 | 14 | 14 |
| (MPa) | | | | | | | | | | | |
| Notched Charpy | 25 | 6.1 | 7 | 5 | 4.4 | 5.1 | 11 | 6.1 | 7.5 | 6.5 | 6.2 |
| (kJ/m²) | | | | | | | | | | | |
| Unnotched Charpy | 171 | 241 | 243 | 267 | 251 | 245 | 203 | 216 | 216 | 210 | 223 |
| (kJ/m²) | | | | | | | | | | | |
| Notched IZOD (kJ/m²) | 23 | 4.7 | 5.3 | 4.2 | 4.5 | 4.5 | 8.2 | 6.9 | 7.3 | 7.9 | 7.3 |
| Heat Deflection | 44 | 44 | 43 | 44 | 44 | 36 | 38 | 41 | 40 | 41 | 51 |
| Temperature, ° C. | | | | | | | | | | | |
| YI | 16 | 17 | 15 | 16 | 15 | 46 | 40 | 46 | 45 | 44 | 18 |

The UL94 ratings in Tables 2 and 4 are reported with the burn time in seconds. Thus, for example, V-2:0 had a burn time of zero seconds, but it exhibited a flaming drip and ignited the cotton in the test, enforcing automatic V-2 rating.

The formulations in Table 3 having the dimer demonstrated an improvement over polyamide resins in Table 1 in terms of having a higher elongation at break, % and improved performance in the UL-94 testing.

The following embodiments are contemplated. All combinations of features and embodiments are contemplated.

### Embodiments

The following embodiments are contemplated. All combinations of features and embodiments are contemplated.

Embodiment 1: A polyamide composition comprising: 50 to 90% by weight of an aliphatic polyamide comprising a dimer monomer having 18 to 44 carbon atoms; and 3 to 40% by weight of a non-halogen flame retardant composition, wherein the entirety of the components amounting to 100% by weight. The non-halogen flame retardant composition comprises a polyalcohol, and one or more phosphorous-containing flame retardants, nitrogen-containing flame retardants or combinations thereof.

Embodiment 2: The polyamide composition of embodiment 1, comprising 65 to 85% by weight of the aliphatic polyamide.

Embodiment 3: The polyamide composition of any one of embodiments 1 or 2, wherein the dimer monomer comprises a dimer acid monomer or a dimer amine monomer.

Embodiment 4: The polyamide composition of any one of embodiments 1-3, wherein the dimer monomer has 18 to 40 carbon atoms, or preferably 20 to 36 carbon atoms.

Embodiment 5: The polyamide composition of any one of embodiments 1-4, wherein the aliphatic polyamide comprises from 5 to 55% by weight of the dimer monomer.

Embodiment 6: The polyamide composition of any one of embodiments 1-5, wherein the aliphatic polyamide comprises a first monomer having 10 to 14 carbon atoms.

Embodiment 7: The polyamide composition of embodiment 6, wherein the first monomer comprises a diacid having 10 to 14 carbon atoms or a diamine having 10 to 14 carbon atoms.

Embodiment 8: The polyamide composition of embodiment 6, wherein the aliphatic polyamide comprises from 25 to 90% by weight of the first monomer.

Embodiment 9: The polyamide composition of any one of embodiments 1-8, wherein the aliphatic polyamide comprises a second monomer having 6 carbon atoms.

Embodiment 10: The polyamide composition of embodiment 9, wherein the second monomer comprises a diacid having 6 carbon atoms or a diamine having 6 carbon atoms.

Embodiment 11: The polyamide composition of embodiment 10, wherein the aliphatic polyamide comprises from 25 to 90% by weight of the second monomer.

Embodiment 12: The polyamide composition of any one of embodiments 1-11, wherein the aliphatic polyamide is a compound of Formula A or Formula B:

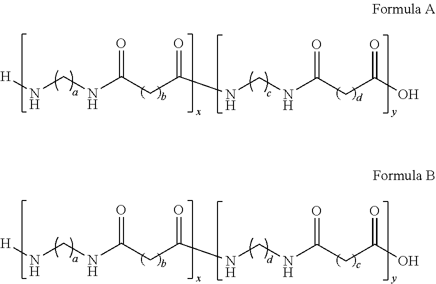

wherein X+Y=100% by weight for the copolymers, wherein a, b, c, d, are from 4 to 44, provided that:
a is 6 or less, then b is from 10 to 14 or b is 6 or less, then a is from 10 to 14;
c is 14 or less; and
d is from 16 to 44.

Embodiment 13: The polyamide composition of any one of embodiments 1-12, wherein the aliphatic polyamide has an initial elongation at break of greater than 100% according to ISO 527-1 (2019).

Embodiment 14: The polyamide composition of any one of embodiments 1-13, wherein the aliphatic polyamide has a viscosity number (meta-cresol) of greater than 150 ml/g.

Embodiment 15: The polyamide composition of any one of embodiments 1-14, wherein the polyalcohol comprises at least one from the group of pentaerythritol, dipentaerythritol, tripentaerythritol or combinations thereof.

Embodiment 16: The polyamide composition of any one of embodiments 1-15, wherein the polyamide composition comprises from 0.5 to 10% by weight of the polyalcohol.

Embodiment 17: The polyamide composition of any one of embodiments 1-16, wherein the phosphorous-containing flame retardants comprise at least one from the group of phosphazenes, polyphosphates, polyphosphonates, aryl phosphates, organophosphates, diphosphates, or combinations thereof.

Embodiment 18: The polyamide composition of embodiment 17, comprising from 2.5% by weight to 30% by weight of the phosphorous-containing flame retardants.

Embodiment 19: The polyamide composition of any one of embodiments 17 or 18, wherein the phosphazenes comprise cyclic phenoxyphosphazene, linear phenoxy phosphazene, or phenoxy phosphazene.

Embodiment 20: The polyamide composition of embodiment 19, wherein the cyclic phenoxyphosphazene is a compound of the formula C:

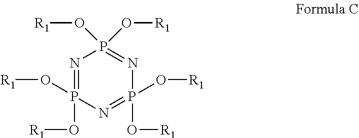

where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

Embodiment 21: The polyamide composition of embodiment 19, wherein the phosphazenes comprise hexaphenoxycyclotriphosphazene, octaphenoxycyclotetraphosphazene, or decaphenoxycyclopentaphosphazene.

Embodiment 22: The polyamide composition of embodiment 17, wherein the phosphazenes comprise a compound of formula D or E:

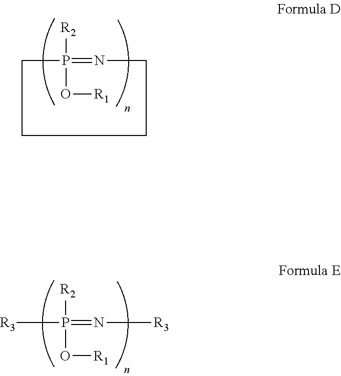

where R₁ is a hydrogen atom, C₁₋₂₀-alkyl, C₆₋₃₀-aryl, C₆₋₃₀-arylalkyl or C₆₋₃₀-alkyl substituted aryl;
R₂ is a hydrogen atom, oxygen group, hydroxyl group, amino group, an —O—R₁ group, C₁-C₂₀-alkyl, C₆-C₃₀-aryl, C₆-C₃₀-arylalkyl or C₆-C₃₀-alkyl substituted aryl;
each R₃ is the same or different and is —N═P(O—R₁)₃, —N═P(O)O—R₁, —P(O—R₁)₄, —P(O)(O—R₁)₂, C₁₋₂₀-alkyl, C₆₋₃₀-aryl, C₆₋₃₀-arylalkyl or C₆₋₃₀-alkyl substituted aryl; and
n is an integer of 3 to 1000.

Embodiment 23: The polyamide composition of embodiment 17, wherein the polyphosphonates is a compound of the formula (F):

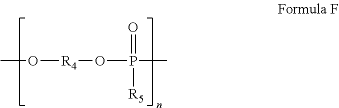

where R₄ is a substituted or unsubstituted C₆₋₃₀-aryl or C₆₋₃₀-arylalkyl;
R₅ is a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₁₋₆-alkyl; and
n is from 2 to 200.

Embodiment 24: The polyamide composition of embodiment 17, wherein the aryl phosphate is a compound of Formula G:

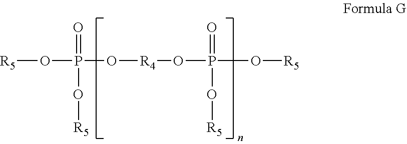

where R₄ is a substituted or unsubstituted C₆₋₃₀-aryl or C₆₋₃₀-arylalkyl;
R₅ are each independently a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₆₋₂₀-aryl, or C₆₋₂₀-arylalkyl; and
n is from 1 to 5.

Embodiment 25: The polyamide composition of embodiment 17, wherein the diphosphonates is a compound of Formula H:

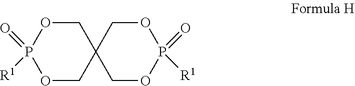

where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

Embodiment 26: The polyamide composition of embodiment 17, wherein the diphosphonates is dimethyl pentaerythritol diphosphonate, dibenzyl pentaerythritol diphosphonate, diphenyl pentaerythritol diphosphonate and dinaphthyl pentaerythritol diphosphonate.

Embodiment 27: The polyamide composition of any one of embodiments 1-26, wherein the nitrogen-containing flame retardants comprise at least one from the group of triazines, hindered amines, or combinations thereof.

Embodiment 28: The polyamide composition of embodiment 27, wherein the triazines comprise at least one from the group of melamine phosphates, melamine cyanurates, or combinations thereof.

Embodiment 29: The polyamide composition of embodiment 28, comprising from 3 to 30% by weight of melamine cyanurate.

Embodiment 30: The polyamide composition of any one of embodiments 1-29, comprising from 0.5 to 10% by weight of plasticizer.

Embodiment 31: The polyamide composition of embodiment 30, comprising from 1 to 5% by weight of a plasticizer.

Embodiment 32: The polyamide composition of embodiment 30, wherein the plasticizer comprises an ester of glycols, an ester of C₆ to C₂₀ aliphatic acids, an ester of C₆ to C₂₀ aromatic acids, or combinations thereof.

Embodiment 33: The polyamide composition of any one of embodiments 1-32, comprising less than or equal to 2% by weight of an antioxidant.

Embodiment 34: The polyamide composition of any one of embodiments 1-33, comprising less than or equal to 2% by weight of an ethylene-methacrylic acid copolymer or a fluoropolymer.

Embodiment 35: The polyamide composition of any one of embodiments 1-34, comprising less than or equal to 5% by weight of a lubricant.

Embodiment 36: The polyamide composition of any one of embodiments 1-35, wherein the polyamide composition has an elongation at break of greater than 100% according to ISO 527-1 (2019).

Embodiment 37: The polyamide composition of any one of embodiments 1-36, wherein the polyamide composition has a UL94 V-0 rating at 0.4 mm, UL94 V-0 rating at 0.75 mm, UL94 V-0 rating at 1.5 mm, UL94 V-0 rating at 3 mm, UL94 V-2 rating at 0.4 mm, UL94 V-2 rating at 0.75 mm, UL94 V-2 rating at 1.5 mm, or UL94 V-2 rating at 3 mm.

Embodiment 38: A three-dimensional article comprising the polyamide composition of any one of embodiments 1-37.

Embodiment 39: The three-dimensional article of embodiment 38, wherein the three-dimensional article comprises moldings, injection-molded parts, extrusion compounds and/or extruded parts.

Embodiment 40: The three-dimensional article of anyone of embodiments 38 or 39, wherein the three-dimensional article comprises antenna frames, bus bars, cables, capacitor housings, cell phone frames, circuit boards, circuit breakers, coil elements, connector sockets, connectors, terminal blocks, encapsulating compounds, engine covers, flexible printed circuit boards, lamp housings, laptop frames, LED housings, plug connectors, power plugs, sensor housings, or other electronic components or housings.

Embodiment 41: A polyamide composition comprising 50 to 90% by weight of an aliphatic polyamide, preferably comprising a dimer monomer, and 3 to 40% by weight of a non-halogen flame retardant composition comprising a polyalcohol; a triazine; a polyphosphonate; an aryl phosphate; and a diphosphonate, a phosphazene, and/or a plasticizer, wherein the entirety of the components amounting to 100% by weight.

Embodiment 42: The polyamide composition of embodiment 41, comprising 65 to 85% by weight of the aliphatic polyamide.

Embodiment 43: The polyamide composition of any one of embodiments 41 or 42, wherein the dimer monomer comprises a dimer acid monomer or a dimer amine monomer.

Embodiment 44: The polyamide composition of any one of embodiments 41-43, wherein the dimer monomer has 18 to 44 carbon atoms.

Embodiment 45: The polyamide composition of any one of embodiments 41-44, wherein the aliphatic polyamide comprises from 5 to 55% by weight of the dimer monomer.

Embodiment 46: The polyamide composition of any one of embodiments 41-45, wherein the aliphatic polyamide comprises a first monomer having 10 to 14 carbon atoms.

Embodiment 47: The polyamide composition of embodiment 46, wherein the first monomer comprises a diacid having 10 to 14 carbon atoms or a diamine having 10 to 14 carbon atoms.

Embodiment 48: The polyamide composition of embodiment 46, wherein the aliphatic polyamide comprises from 25 to 90% by weight of the first monomer.

Embodiment 49: The polyamide composition of any one of embodiments 41-48, wherein the aliphatic polyamide comprises a second monomer having 6 carbon atoms.

Embodiment 50: The polyamide composition of embodiment 49, wherein the second monomer comprises a diacid having 6 carbon atoms or a diamine having 6 carbon atoms.

Embodiment 51: The polyamide composition of embodiment 50, wherein the aliphatic polyamide comprises from 25 to 90% by weight of the second monomer.

Embodiment 52: The polyamide composition of anyone of embodiments 41-51, wherein the aliphatic polyamide is a compound of Formula A or Formula B:

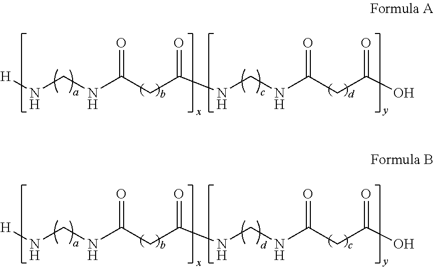

wherein X+Y=100% by weight for the copolymers, wherein a, b, c, d, are from 4 to 44, provided that:
a is 6 or less, then b is from 10 to 14 or b is 6 or less, then a is from 10 to 14;
c is 14 or less; and
d is from 16 to 44.

Embodiment 53: The polyamide composition of any one of embodiments 41-52, wherein the aliphatic polyamide has an initial elongation at break of greater than 100% according to ISO 527-1 (2019).

Embodiment 54: The polyamide composition of any one of embodiments 41-53, wherein the aliphatic polyamide has a viscosity number (meta-cresol) of greater than 150 ml/g.

Embodiment 55: The polyamide composition of any one of embodiments 41-54, wherein the polyalcohol comprises at least one from the group of pentaerythritol, dipentaerythritol, tripentaerythritol or combinations thereof.

Embodiment 56: The polyamide composition of any one of embodiments 41-55, wherein the polyamide composition comprises from 0.5 to 10% by weight of the polyalcohol.

Embodiment 57: The polyamide composition of any one of embodiments 41-56, wherein the phosphazenes comprise cyclic phenoxyphosphazene, linear phenoxy phosphazene, or phenoxy phosphazene.

Embodiment 58: The polyamide composition of embodiment 57, wherein the cyclic phenoxyphosphazene is a compound of the formula C:

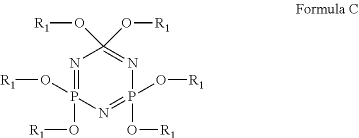

where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

Embodiment 59: The polyamide composition of embodiment 57, wherein the phosphazenes comprise hexaphenoxycyclotriphosphazene, octaphenoxycyclotetraphosphazene, or decaphenoxycyclopentaphosphazene.

Embodiment 60: The polyamide composition any one of embodiments 41-59, wherein the phosphazenes comprise a compound of formula D or E:

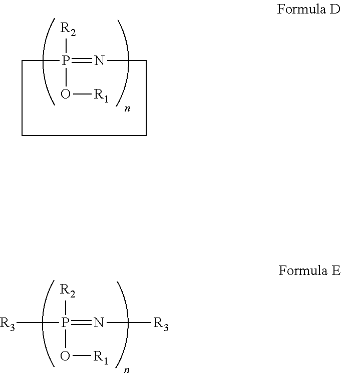

where R₁ is a hydrogen atom, C₁₋₂₀-alkyl, C₆₋₃₀-aryl, C₆₋₃₀-arylalkyl or C₆₋₃₀-alkyl substituted aryl;
R₂ is a hydrogen atom, oxygen group, hydroxyl group, amino group, an —O—R₁ group, C₁-C₂₀-alkyl, C₆-C₃₀-aryl, C₆-C₃₀-arylalkyl or C₆-C₃₀-alkyl substituted aryl;
each R₃ is the same or different and is-N═P(O—R₁)₃, —N═P(O)O—R₁, —P(O—R₁)₄, —P(O)(O—R₁)₂, C₁₋₂₀-alkyl, C₆₋₃₀-aryl, C₆₋₃-arylalkyl or C₆₋₃₀-alkyl substituted aryl; and
n is an integer of 3 to 1000.

Embodiment 61: The polyamide composition any one of embodiments 41-60, wherein the polyphosphonates is a compound of the formula (F):

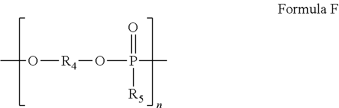

where R₄ is a substituted or unsubstituted C₆₋₃₀-aryl or C₆₋₃₀-arylalkyl;
R₅ is a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₁₋₆-alkyl; and
n is from 2 to 200.

Embodiment 62: The polyamide composition any one of embodiments 41-61, wherein the aryl phosphate is a compound of Formula G:

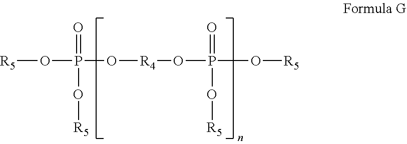

where R₄ is a substituted or unsubstituted C₆₋₃₀-aryl or C₆₋₃₀-arylalkyl;
R₅ are each independently a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₆₋₂₀-aryl, or C₆₋₂₀-arylalkyl; and
n is from 1 to 5.

Embodiment 63: The polyamide composition any one of embodiments 41-62, wherein the diphosphonates is a compound of Formula H:

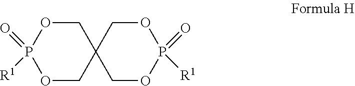

where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

Embodiment 64: The polyamide composition of any one of embodiments 41-63, wherein the diphosphonates is dimethyl pentaerythritol diphosphonate, dibenzyl pentaerythritol diphosphonate, diphenyl pentaerythritol diphosphonate and dinaphthyl pentaerythritol diphosphonate.

Embodiment 65: The polyamide composition of any one of embodiments 41-64, wherein the triazines comprise at least one from the group of melamine phosphates, melamine cyanurates, or combinations thereof.

Embodiment 66: The polyamide composition of embodiment 65, comprising from 3 to 30% by weight of melamine cyanurate.

Embodiment 67: The polyamide composition of any one of embodiments 41-66, comprising from 0.5 to 10% by weight of the plasticizer.

Embodiment 68: The polyamide composition of any one of embodiments 41-67, comprising from 1 to 5% by weight of the plasticizer.

Embodiment 69: The polyamide composition of any one of embodiments 41-68, wherein the plasticizer comprises an ester of glycols, an ester of C₆ to C₂₀ aliphatic acids, an ester of C₆ to C₂₀ aromatic acids, or combinations thereof.

Embodiment 70: The polyamide composition of any one of embodiments 41-69, comprising less than or equal to 2% by weight of an antioxidant.

Embodiment 71: The polyamide composition of any one of embodiments 41-70, comprising less than or equal to 2% by weight of an ethylene-methacrylic acid copolymer or a fluoropolymer.

Embodiment 72: The polyamide composition of any one of embodiments 41-71, comprising less than or equal to 5% by weight of a lubricant.

Embodiment 73: The polyamide composition of any one of embodiments 41-72, wherein the polyamide composition has an elongation at break of greater than 100% according to ISO 527-1 (2019).

Embodiment 74: The polyamide composition of anyone of embodiments 41-73, wherein the polyamide composition has a UL94 V-0 rating at 0.4 mm, UL94 V-0 rating at 0.75 mm, UL94 V-0 rating at 1.5 mm, UL94 V-0 rating at 3 mm, UL94 V-2 rating at 0.4 mm, UL94 V-2 rating at 0.75 mm, UL94 V-2 rating at 1.5 mm, or UL94 V-2 rating at 3 mm.

Embodiment 75: A three-dimensional article comprising the polyamide composition of any one of embodiments 41-74.

Embodiment 76: The three-dimensional article of embodiment 75, wherein the three-dimensional article comprises moldings, injection-molded parts, extrusion compounds and/or extruded parts.

Embodiment 77: The three-dimensional article of anyone of embodiments 75 or 76, wherein the three-dimensional article comprises antenna frames, bus bars, cables, capacitor housings, cell phone frames, circuit boards, circuit breakers, coil elements, connector sockets, connectors, terminal blocks, encapsulating compounds, engine covers, flexible printed circuit boards, lamp housings, laptop frames, LED housings, plug connectors, power plugs, sensor housings, or other electronic components or housings.

Embodiment 78: A polyamide composition comprising: 50 to 90% by weight of an aliphatic polyamide comprising; and 3 to 40% by weight of a non-halogen flame retardant composition, wherein the entirety of the components amounting to 100% by weight. The non-halogen flame retardant composition comprises a polyalcohol, and one or more phosphorous-containing flame retardants, nitrogen-containing flame retardants or combinations thereof.

While the disclosure has been described in detail, modifications within the spirit and scope of the disclosure will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the disclosure and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is byway of example only, and is not intended to limit the disclosure.

We claim:

1. A polyamide composition comprising:
50 to 90% by weight of an aliphatic polyamide comprising a dimer monomer having 18 to 44 carbon atoms; and
3 to 40% by weight of a non-halogen flame retardant composition comprising:
a polyalcohol; and
one or more phosphorous-containing flame retardants, nitrogen-containing flame retardants or combinations thereof,
wherein the entirety of the components amounting to 100% by weight.

2. The polyamide composition of claim 1, wherein the polyamide composition comprises 65% by weight to 85% by weight of the aliphatic polyamide and from 5% by weight to 55% by weight of the dimer monomer.

3. The polyamide composition of any one of claims 1 or 2, wherein the aliphatic polyamide is a compound of Formula A or Formula B: 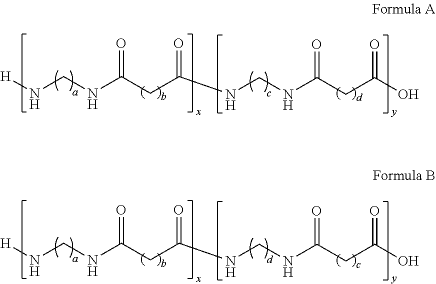
wherein X+Y=100% by weight for the copolymers, wherein a, b, c, d, are from 4 to 44, provided that:
a is 6 or less, then b is from 10 to 14 or b is 6 or less, then a is from 10 to 14;
c is 14 or less; and
d is from 16 to 44.

4. The polyamide composition of any one of claims 1-3, comprising from 0.5 to 10% by weight of the polyalcohol, wherein the polyalcohol comprises at least one from the group of pentaerythritol, dipentaerythritol, tripentaerythritol or combinations thereof.

5. The polyamide composition of any one of claims 1-4, comprising from 2.5% by weight to 30% by weight of the phosphorous-containing flame retardants, wherein the phosphorous-containing flame retardants comprise at least one from the group of phosphazenes, polyphosphates, polyphosphonates, aryl phosphates, organophosphates, diphosphates, or combinations thereof.

6. The polyamide composition of claim 5, wherein the phosphazenes comprise cyclic phenoxyphosphazene, linear phenoxy phosphazene, or phenoxy phosphazene.

7. The polyamide composition of claim 6, wherein the cyclic phenoxyphosphazene is a compound of the formula C: 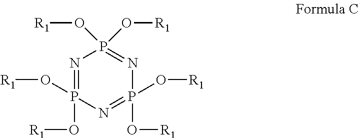
where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

8. The polyamide composition of claim 5, wherein the phosphazenes comprise a compound of formula D or E: 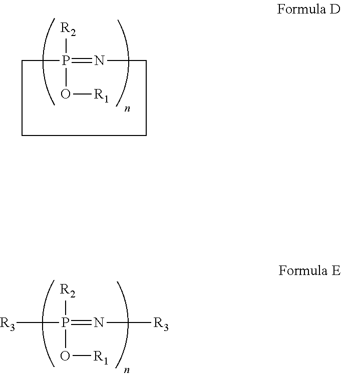
where R₁ is a hydrogen atom, C₁₋₂₀-alkyl, C₆₋₃₀-aryl, C₆₋₃₀-arylalkyl or C₆₋₃₀-alkyl substituted aryl;
R₂ is a hydrogen atom, oxygen group, hydroxyl group, amino group, an —O—R₁ group, C₁-C₂₀-alkyl, C₆-C₃₀-aryl, C₆-C₃₀-arylalkyl or C₆-C₃₀-alkyl substituted aryl;
each R₃ is the same or different and is —N═P(O—R₁)₃, —N═P(O)O—R₁, —P(O—R₁)₄, —P(O)(O—R₁)₂, C₁₋₂₀-alkyl, C₆₋₃₀-aryl, C₆₋₃₀-arylalkyl or C₆₋₃₀-alkyl substituted aryl; and
n is an integer of 3 to 1000.

9. The polyamide composition of claim 5, wherein the polyphosphonates is a compound of the formula F or formula G: 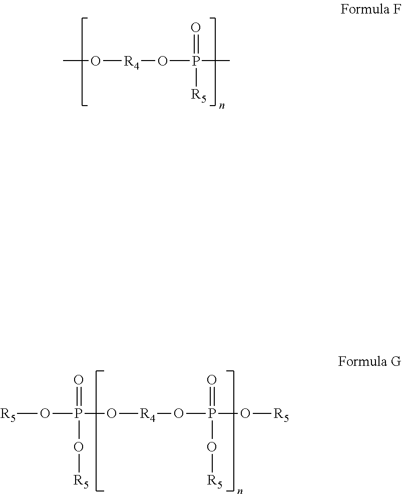
where R₄ is a substituted or unsubstituted C₆₋₃₀-aryl or C₆₋₃₀-arylalkyl;
R₅ are each independently a C₁₋₂₀-alkyl, C₂₋₂₀-alkene, C₂₋₂₀-alkyne, C₅₋₂₀-cycloalkyl, C₆₋₂₀-aryl, or C₆₋₂₀-arylalkyl, and preferably R₅ is a C₁₋₆-alkyl; and
n is from 2 to 200 or n is 1 to 5.

10. The polyamide composition of claim 5, wherein the diphosphonates is a compound of Formula H: 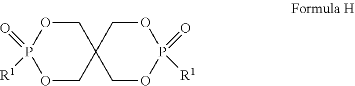
where each R₁ is the same or different and is a hydrogen atom, C₁₋₂₀-alkyl, C₆₋₃₀-aryl, C₆₋₃₀-arylalkyl or C₆₋₃₀-alkyl substituted aryl.

11. The polyamide composition of any one of claims 1-10, comprising from 2.5% by weight to 30% by weight of the nitrogen-containing flame retardants, wherein the nitrogen-containing flame retardants comprise at least one from the group of triazines, hindered amines, or combinations thereof.

12. The polyamide composition of any one of claims 1-11, comprising less than or equal to 5% by weight of a lubricant, from 0.5 to 10% by weight of a plasticizer, less than or equal to 2% by weight of an antioxidant, or less than or equal to 2% by weight of an ethylene-methacrylic acid copolymer or a fluoropolymer.

13. The polyamide composition of any one of claims 1-12, wherein the polyamide composition has an elongation at break of greater than 100% according to ISO 527-1 (2019).

14. The polyamide composition of any one of claims 1-13, wherein the polyamide composition has a UL94 V-0 rating at 0.4 mm, or a UL94 V-2 rating at 0.4 mm.

15. A three-dimensional article comprising the polyamide composition of any one of claims 1-14, wherein the three-dimensional article comprises moldings, injection-molded parts, extrusion compounds and/or extruded parts.
